(19) United States
(12) Patent Application Publication
(10) Pub. No.: US 2006/0221967 A1
(43) Pub. Date: Oct. 5, 2006

(54) Methods for performing packet classification

(76) Inventors: Harsha L. Narayan, Santa Clara, CA (US); Alok Kumar, Santa Clara, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/096,960

(22) Filed: Mar. 31, 2005

(51) Int. Cl. H04L 12/56; H04L 12/28; G01R 31/08; G08C 15/00; H04L 12/26; G06F 11/00; H04J 3/14; H04J 1/16; H04L 1/00

(52) U.S. Cl. 370/392; 370/229; 370/400

(57) ABSTRACT

Methods for performing packet classification via partitioned bit vectors. Rules in an access control list (ACL) are partitioned into a plurality of partitions, wherein each partition is defined by a meta-rule comprising a set of filter dimension ranges and/or values covering the rules in that partition. Filter data structures comprising rule bit vectors are then built, each including multiple filter entries defining packet header filter criteria corresponding to one or more filter dimensions. Partition bit vectors identifying, for each filter entry, any partition having a meta-rule defining a filter dimension range or value that covers that entry's packet header filter criteria are also generated and stored in a corresponding data structure.

### FIELD OF THE INVENTION

The field of invention relates generally to computer and telecommunications networks and, more specifically but not exclusively relates to techniques for performing packet classification at line rate speeds.

### BACKGROUND INFORMATION

Network devices, such as switches and routers, are designed to forward network traffic, in the form of packets, at high line rates. One of the most important considerations for handling network traffic is packet throughput. To accomplish this, special-purpose processors known as network processors have been developed to efficiently process very large numbers of packets per second. In order to process a packet, the network processor (and/or network equipment employing the network processor) needs to extract data from the packet header indicating the destination of the packet, class of service, etc., store the payload data in memory, perform packet classification and queuing operations, determine the next hop for the packet, select an appropriate network port via which to forward the packet, etc. These operations are generally referred to as “packet processing” operations.

Traditional routers, which are commonly referred to as Layer 3 Switches, perform two major tasks in forwarding a packet: looking up the packet's destination address in the route database (also referred to a the a route or forwarding table), and switching the packet from an incoming link to one of the routers outgoing links. With recent advances in lookup algorithm and improved network processors, it appears that layer 3 switches should be able to keep up with increasing line rate speeds, such as OC-192 or higher.

Increasingly, however, users are demanding, and some vendors are providing a more discriminating form of router forwarding. This new vision of forwarding is called Layer 4 Forwarding because routing decisions can be based on headers available at Layer 4 or higher in the OSI architecture. Layer 4 forwarding is performed by packet classification routers (also referred to as Layer 4 Switches), which support “service differentiation.” This enables the router to provide enhanced functionality, such as blocking traffic from a malicious site, reserving bandwidth for traffic between company sites, and provide preferential treatment to one kind of traffic (e.g., online database transactions) over other kinds of traffic (e.g., Web browsing). In contrast, traditional routers do not provide service differentiation because they treat all traffic going to a particular address in the same way.

In packet classification routers, the route and resources allocated to a packet are determined by the destination address as well as other header fields of the packet such as the source address and TCP/UDP port numbers. Layer 4 switching unifies the forwarding functions required by firewalls, resource reservations, QoS routing, unicast routing, and multicast routing into a single unified framework. In this framework, forwarding database of a router consists of a potentially large number of filters on key header fields. A given packet header can match multiple filters; accordingly, each filter is given a cost, and the packet is forwarded using the least cost matching filter.

Traditionally, the rules for classifying a message are called filters (or rules in firewall terminology), and the packet classification problem is to determine the lowest cost matching filter or rule for each incoming message at the router. The relevant information is contained in K distinct header fields in each message (packet). For instance, the relevant fields for an IPv4 packet could comprise the Destination Address (32 bits), the Source Address (32 bits), the Protocol Field (8 bits), the Destination Port (16 bits), the Source Port (16 bits), and, optionally, the TCP flags (8 bits). Since the number of flags is limited, the protocol and flags may be combined into one field in some implementations.

The filter database of a Layer 4 Switch consists of a finite set of filters, filt₁, filt₂ . . . filt_{N}. Each filter is a combination of K values, one for each header field. Each field in a filter is allowed three kinds of matches: exact match, prefix match, or range match. In an exact match, the header field of the packet should exactly match the filter field. In a prefix match, the filter field should be a prefix of the header field. In a range match, the header values should like in the range specified by the filter. Each filter filtᵢ has an associated directive dispᵢ, which specifies how to forward a packet matching the filter.

Since header processing for a packet may match multiple filters in the database, a cost is associated with each filter to determine the appropriate (best) filter to use in such cases. Accordingly, each filter F is associated with a cost(F), and the goal is to find the filter with the least cost matching the packet's header.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1a shows an exemplary set of packet classification rules comprise a rule database;

FIGS. 1b-f show various rule bit vectors derived from the rule database of FIG. 1a, wherein FIGS. 1b, 1c, 1d, 1e, and 1f respectively show rule bit vectors corresponding to source address prefixes, destination address prefixes, source port values, destination port values, and protocol values;

FIG. 2a depicts rule bit vectors corresponding to an exemplary trie structure;

FIG. 2b shows parallel processing of various packet header field data to identify an applicable rule for forwarding a packet;

FIG. 2c shows a table containing an exemplary set of packet header values and corresponding matching bit vectors corresponding to the rules defined the rule database of FIG. 1a;

FIG. 3a is a schematic diagram of a conventional recursive flow classification (RFC) lookup process and an exemplary RFC reduction tree configuration;

FIG. 3b is a schematic diagram illustrating the memory consumption employed for the various RFC data structures of FIG. 3a;

FIGS. 4a and 4b are schematic diagram depicting various bitmap to header field range mappings;

FIG. 5a is a schematic diagram depicting the result of an exemplary cross-product operation using convention RFC techniques;

FIG. 5b is a schematic diagram illustrating the result of a similar cross-product operation using optimized bit vectors, according to one embodiment of the invention;

FIG. 5c is a diagram illustrating the mapping of previous rule bit vector identifiers (IDs) to new IDs;

FIG. 6a illustrates a set of exemplary chunks prior to applying rule bit optimization, while FIG. 6b illustrates modified ID values in the chunks after applying rule bit vector optimization;

FIGS. 7a and 7b show a flowchart illustrating operations and logic for performing rule bit vector optimization, according to one embodiment of the invention;

FIG. 8 is a schematic diagram illustrating an exemplary implementation of rule database splitting, according to one embodiment of the invention;

FIG. 9 shows a flowchart illustrating operations and logic for generating partitioned data structures using rule database splitting, according to one embodiment of the invention;

FIG. 10 is a flowchart illustrating operations performed during build and run-time phases under one embodiment of the rule bit vector optimization scheme;

FIG. 11 is a flowchart illustrating operations performed during build and run-time phases under one embodiment of the rule database splitting scheme;

FIG. 12 depicts an exemplary partitioning scheme and rule map employed for the example of FIG. 17b;

FIG. 13 depicts a rule database and an exemplary partitioning scheme employed for the example of FIGS. 16a-e and 18;

FIG. 14 depicts an exemplary rule map employed for the example of FIG. 18;

FIG. 15a is a flowchart illustrating operations performed by one embodiment of an build phase during which a partitioning scheme is defined, and corresponding data structures are built;

FIG. 15b is a flowchart illustrating operations performed by one embodiment of a rule-time phase that performs lookup operations on the data structures build during the build phase;

FIGS. 16a-e show various rule bit vectors derived from the rule database of FIG. 13, wherein FIG. 16a, 16b, 16c, 16d, 16e, and 16f respectively show rule bit vectors corresponding to source address prefixes, destination address prefixes, source port values, destination port values, and protocol values;

FIG. 17a is a schematic diagram depicting run-time operations and logic performed in accordance with the flowchart of FIG. 15b;

FIG. 17b is a schematic diagram depicting further details of index rule map processing using the rule map of FIG. 12;

FIG. 18 is a diagram illustrating the rule bit vectors, partition bit vectors, and resulting ANDed vectors corresponding to an exemplary set of packet header data using the partitioning scheme of FIG. 13 and rule map of FIG. 14;

FIG. 19a is a table including data identifying the number of unique source prefixes, destination prefixes, and prefix pairs in exemplary ACLs;

FIG. 19b is a table including statistical data relating to the ACLs of FIG. 19a;

FIG. 20 depicts an exemplary set of data illustrative of a simple prefix pair bit vector (PPBV) implementation;

FIG. 21 shows an exemplary rule set and the source and destination PPBVs and List-of-PPPFs generated therefrom;

FIG. 22 is a schematic diagram illustrating operations that are performed during the PPBV scheme;

FIG. 23 shows an exemplary set of PPBV data stored under the Option_Fast_Update storage scheme;

FIG. 24 is a schematic diagram depicting an ORing operation that may be performed to lookup to enhance the performance of one embodiment of the PPBV scheme; and

FIG. 25 is a schematic diagram of a network line card employing a network processor that may be used to execute software to support the run-time phase packet classification operations described herein.

### DETAILED DESCRIPTION

Embodiments of methods and apparatus for performing packet classification are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Throughout this specification, several terms of art are used. These terms are to take on their ordinary meaning in the art from which they come, unless specifically defined herein or the context of their use would clearly suggest otherwise. In addition, the following specific terminology is used herein:

ACL: Access Control List (The set of rules that are used for classification).

ACL size: Number of rules in the ACL.

Bitmap: same as bit vector.

Cover: A range p is said to cover a range q, if q is a subset of p. e.g., p=202/7, q=203/8. Or p=* and q=gt 1023.

Database: Same as ACL.

Database size: Same as ACL size.

Prefix pair: The pair (source prefix, destination prefix).

Dependent memory access: If some number of memory accesses can be performed in parallel, i.e. issued at the same time, they are said to constitute one dependent memory access.

More specific prefix: A prefix q is said to be more specific than a prefix p, if q is a subset of p.

Rule bit vector: a single dimension array of bits, with each bit mapped to a respective rule.

Transport level fields: Source port, Destination port, Protocol.

Bit Vector (BV) Algorithm

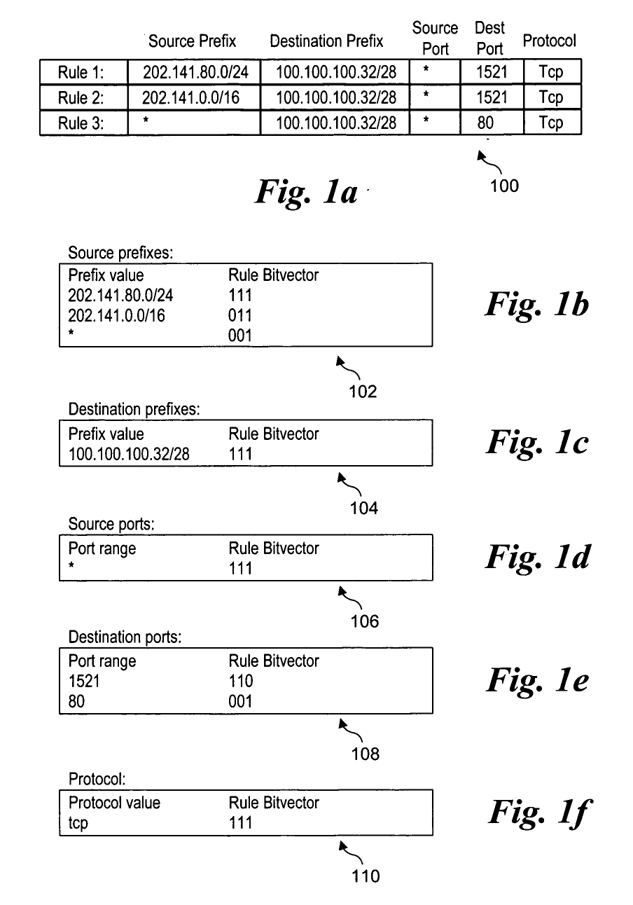

The bit vector (BV) algorithm was introduced by Lakshman and Stiliadis in 1998 (T. V. Lakshman and D. Stiliadis, High Speed Policy-Based Forwarding using Efficient Multidimensional Range Matching, ACM SIGCOMM 1998). Under the bit vector algorithm, a bit map (referred to as a bit vector or bitvector) is associated with each dimension (e.g., header field), wherein the bit vector identifies which rule or filters are applicable to that dimension, with each bit position in the bit vector being mapped to a corresponding rule or filter. For example, FIG. 1a shows a table 100 including set of three rules applicable to a five-dimension implementation based on five packet header fields: Source (IP address) Prefix, Destination (IP address) Prefix, Source Port, Destination Port, and Protocol. For each dimension, a list of unique values (applicable to the classifier) will be stored in a lookup data structure, along with a rule bit vector for that value. For Source and Destination Prefixes, the values will generally correspond to an address range; accordingly, the terms range and values are used interchangeably herein. Respective data structures 102, 104, 106, 108, and 110 for the Source Prefix, Destination Prefix, Source Port, Destination Port, and Protocol field dimensions corresponding to the entries shown table 100 are shown in FIGS. 1b-f.

The rule bit vector is configured such that each bit position i maps to a corresponding i^{th} rule. Under the rule bit vector examples shown in FIGS. 1b-f, the left bit (bit 1) position applies to Rule 1, the middle bit (bit 2) position applies to Rule 2, and the right bit (bit 3) position applies to Rule 3. If a rule covers a given range or value, it is applicable to that range or value. For example, the Source Prefix value for Rule 3 is *, indicating a wildcard character representing all values. Thus bit 3, is set for all of the Source Prefix entries in data structure 102, since all of the entries are covered by the * value. Similarly, bit 2 is set for each of the first and second entries, since the Source prefix for the second entry (202.141.0.0/16) covers the first entry (202.141.80.0/24) (the /N value represents the number of bits in the prefix, while the “0” values represent a wildcard sub-mask in this example). Meanwhile, since the first Source Prefix entry does not cover the second Source Prefix, bit 1 (associated with Rule 1) is only set for the first Source Prefix value in data structure 102.

As discussed above, only the unique values for each dimension need to be stored in a corresponding data structure. Thus, each of Destination Prefix data structure 104, Source Port data structure 106, and Protocol data structure 110 include a single entry, since all the values in table 1 corresponding to their respective dimensions are the same (e.g., all Destination Prefix values are 100.100.100.32/28). Since there are two unique values (1521 and 80) for the Destination Port dimension, Destination Port data structure 108 includes two entries.

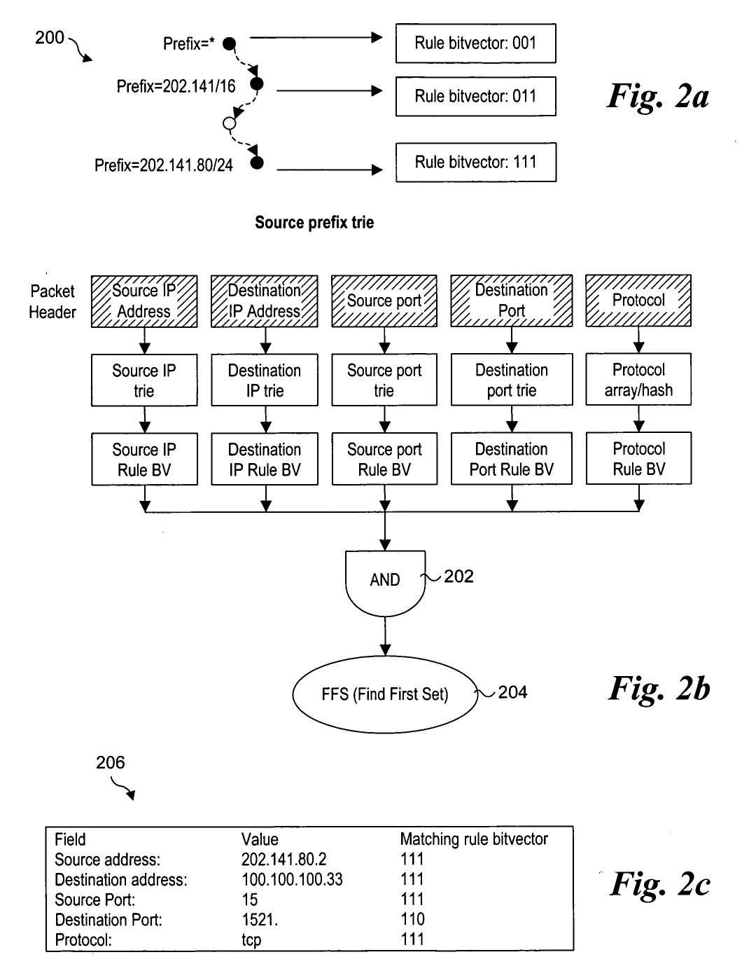

To speed up the lookup process, the unique values for each dimension are stored in a corresponding trie. For example, an exemplary Source Prefix trie 200 corresponding to Source Prefix data structure 102 is schematically depicted in FIG. 2a. Similar tries are used for the other dimensions. Each trie includes a node for each entry in the corresponding dimension data structure. A rule bit vector is mapped to each trie node. Thus, under Source Prefix trie 200, the rule bit vector for a node 202 corresponding to a Source Prefix value of 202.141.80/24 has a value of {111}.

Under the Bit Vector algorithm, the applicable bit vectors for the packet header values for each dimension are searched for in parallel. This is schematically depicted in FIG. 2b. During this process, the applicable trie for each dimension is traversed until the appropriate node in the trie is found, depending on the search criteria used. The rule bit vector for the node is then retrieved. The bit vectors are then combined by ANDing the bits of the applicable bit vector for each search dimension, as depicted by an AND block 202 in FIG. 2b. The highest-priority matching rule is then identified by the leftmost bit that is set. This operation is referred to herein as the Find First Set (FFS) operation, and is depicted by an FFS block 204 in FIG. 2b.

A table 206 containing an exemplary set of packet header values and corresponding matching bit vectors corresponding to the rules defined in table 100 is shown in FIG. 2c. As discussed above, the matching rule bit vectors are ANDed to produce the applicable bit vector, which in this instance is {110}. The first matching rule is then located in the bit vector by FFS block 204. Since the bit 1 is set, the rule to be applied to the packet is Rule 1, which is the highest-priority matching rule.

The example shown in FIGS. 1a-f is a very simple example that only includes three rules. Real-world examples include a much greater number of rules. For example, ACL3 has approximately 2200 rules. Thus, for a linear lookup scheme, memory having a width of 2200 bits (1 bit for each rule in the rule bit vector) would need to be employed. Under current memory architectures, such memory widths are unavailable. While it is conceivable that memories having a width of this order could be made, such memories would not address the scalability issues presented by current and future packet classification implementations. For example, future ACL's may include 10's of thousands of rules. Furthermore, since the heart of the BV algorithm relies on linear searching, it cannot scale to both very large databases and very high speeds.

Recursive Flow Classification (RFC)

Recursive Flow Classification (RFC) was introduced by Gupta and McKeown in 1999 (Pankaj Gupta and Nick McKeown, Packet Classification on Multiple Fields, ACM SIGCOMM 1999). RFC shares some similarities with BV, while also providing some differences. As with BV, RFC also uses rule bit vectors where the i^{th} bit is set if the i^{th} rule is a potential match. (Actually, to be more accurate, there is a small difference between the rule bit vectors of BV and RFC; however, it will be shown that this difference does not exist if the process deals solely with prefixes (e.g., if port ranges are converted to prefixes)). The differences are in how the rule bit vectors are constructed and used. During the construction of the lookup data structure, RFC gives each unique rule bit vector an ID. The RFC lookup process deals only with these IDs (i.e., the rule bit vectors are hidden). However, this construction of the lookup data structure is based upon rule bit vectors.

A cross-producting algorithm was introduced concurrently with BV by Srinivasan et al. (V. Srinivasan, S. Suri, G. Varghese and M. Waldvogel, Fast and Scalable Layer 4 Switching, ACM SIGCOMM 1998). The cross-producting algorithm assigns IDs to unique values of prefixes, port ranges, protocol values. This effectively provides IDs for rule bit vectors (as will be discussed below). During lookup time, cross-producting identifies these IDs using trie lookups for each field. It then concatenates all the IDs for the dimension fields (five in the examples herein) to form a key. This key is used to index a hash table to find the highest-priority matching rule.

The BV algorithm performs cross-producting of rule bit vectors at runtime, using hardware (e.g., the ANDing of rule bit vectors is done by using plenty of AND gates). This reduces memory consumption. Meanwhile, cross-producting operations are intended to be implemented in software. Under cross-producting, IDs are combined (via concatenation), and a single memory access is performed to lookup the hash key index in the hash table. One problem with this approach, however, is that it requires a large number of entries in the hash table, thus consuming a large amount of memory.

RFC is a hybrid of BV and cross-producting, and is intended to be a software algorithm. RFC takes the middle path between BV and cross-producting; it employs IDs for rule bit vectors, like cross-producting, but combines the IDs in multiple memory accesses instead of a single memory access. By doing this, RFC saves on memory compared to cross-producting.

A key contribution of RFC is the novel way in which it identifies the rule bit vectors. Whereas BV and cross-producting identify the rule bit vectors and IDs using trie lookups, RFC does this in a single dependent memory access.

The RFC lookup procedure operates in “phases”. Each “phase” corresponds to one dependent memory access during lookup; thus, the number of dependent memory accesses is equal to the number of phases. All the memory accesses within a given phase are performed in parallel.

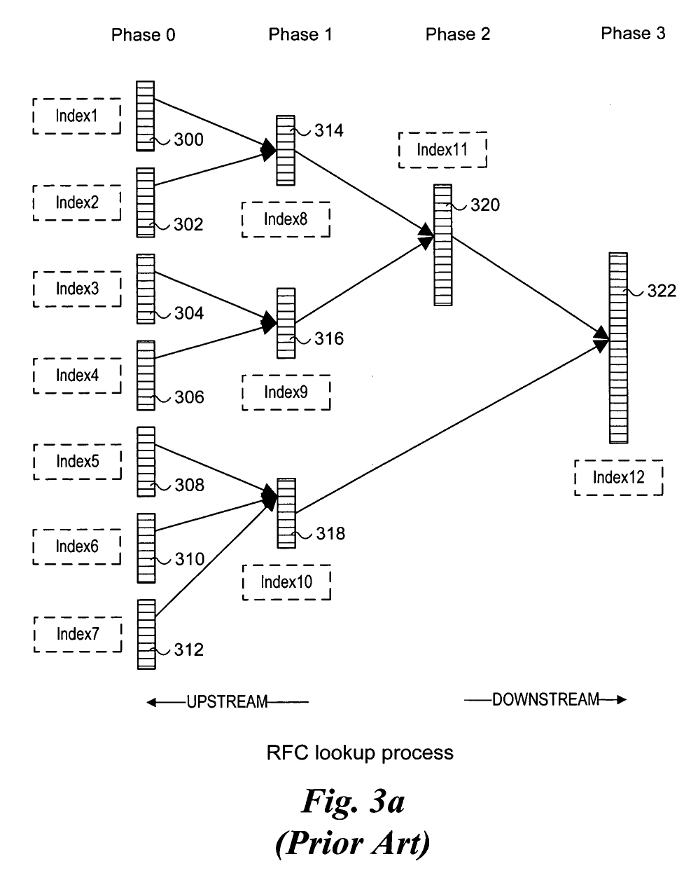

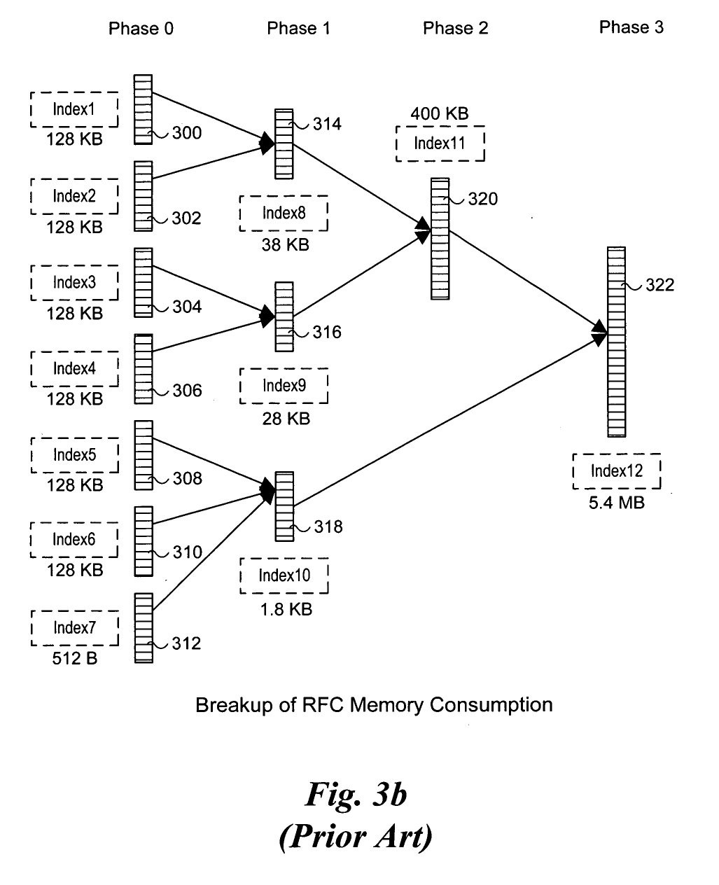

An exemplary RFC lookup process is shown in FIG. 3a. Each of the rectangles with an arrow emanating therefrom or terminating thereat depicts an array. Under RFC, each array is referred to as a “chunk.” A respective index is associated with each chunk, as depicted by the dashed boxes containing an IndexN label. Exemplary values for these indices are shown in Table 1, below:

TABLE 1

| Index | Value |
|---|---|
| Index1 | First 16 bits of source IP address of input packet |
| Index2 | Next 16 bits of source IP address of input packet |
| Index3 | First 16 bits of destination IP address of input packet |
| Index4 | Next 16 bits of destination IP address of input packet |
| Index5 | Source port of input packet |
| Index6 | Destination port of input packet |
| Index7 | Protocol of input packet |
| Index8 | Combine(result of Index1 lookup, result of Index2 lookup) |
| Index9 | Combine(result of Index3 lookup, result of Index4 lookup) |
| Index10 | Combine(result of Index5 lookup, result of Index6 lookup, |
| | result of Index7 lookup) |
| Index11 | Combine(result of Index8 lookup, result of Index9 lookup) |
| Index12 | Combine(result of Index10 lookup, result of Index11 lookup) |

The matching rule obtained is the result of the Index12 lookup.

The result of each lookup is a “chunk ID” (Chunk IDs are IDs assigned to unique rule bit vectors). The way these “chunk IDs” are calculated is discussed below.

As depicted in FIG. 3a, the zeroth phase operates on seven chunks 300, 302, 304, 306, 308, 310, and 312. The first phase operates on three chunks 314, 316, and 318, while the second phase operates on a single chunk 320, and the third phase operates on a single chunk 322. This last chunk 322 stores the rule number corresponding to the first set bit. Therefore, when a index lookup is performed on the last chunk, instead of getting an ID, a rule number is returned.

The indices for chunks 300, 302, 304, 306, 308, 310, and 312 in the zeroth phase respectively comprise source address bits 0-15, source address bits 16-31, destination address bits 0-15, destination address bits 16-31, source port, destination port, and protocol. The indices for a later (downstream) phase are calculated using the results of the lookups for the previous (upstream) phase. Similarly, the chunks in a later phase are generated from the cross-products of chunks in an earlier phase or phases. For example, chunk 314 indexed by Index8 has two arrows coming to it from the top two chunks (300 and 302) of the zeroth phase. Thus, chunk 314 is formed by the cross-producting of the chunks 300 and 302 of the zeroth phase. Therefore, its index, Index8 is given by:
Index8=(Result of Index1 lookup*Number of unique values in chunk 302)+Result of Index2 lookup.

In another embodiment, a concatenation technique is used to calculate the ID. Under this technique, the ID's (indexes) of the various lookups are concatenated to define the indexes for the next (downstream) lookup.

The construction of the RFC lookup data structure will now be described. The construction of the first phase (phase 0) is different from the construction of the remaining phases (phases greater than 0). However, before construction of these phases are discussed, the similarities and differences between the RFC and BV rule bit vectors will be discussed.

In order to understand the difference between BV and RFC bit vectors, let us look at an example. Suppose we have the three ranges shown in Table 2 below. BV would construct three bit vectors for this table (one for each range). Let us assume for now that ranges are not broken up into prefixes. Our motivation is to illustrate the conceptual difference between RFC and BV rule bit vectors. (If we are dealing only with prefixes, the RFC and BV rule bit vectors are the same).

TABLE 2

| | | BV bitmap (We have to set |
|---|---|---|
| Rule # | Range | for all possible matches) |
| Rule1 | 161, 165 | 111 |
| Rule2 | 163, 168. | 111 |
| Rule3 | 162, 166. | 111 |

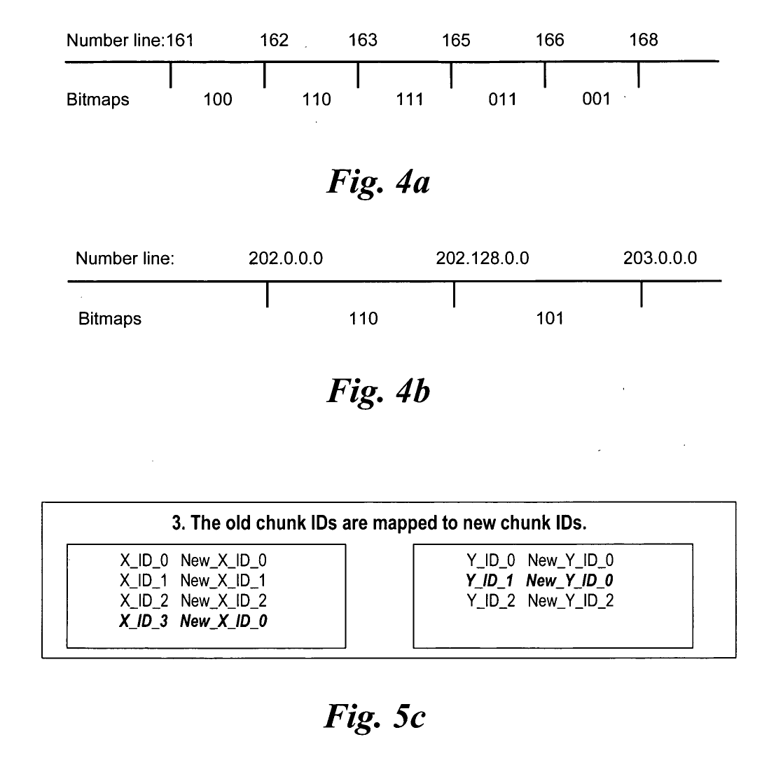

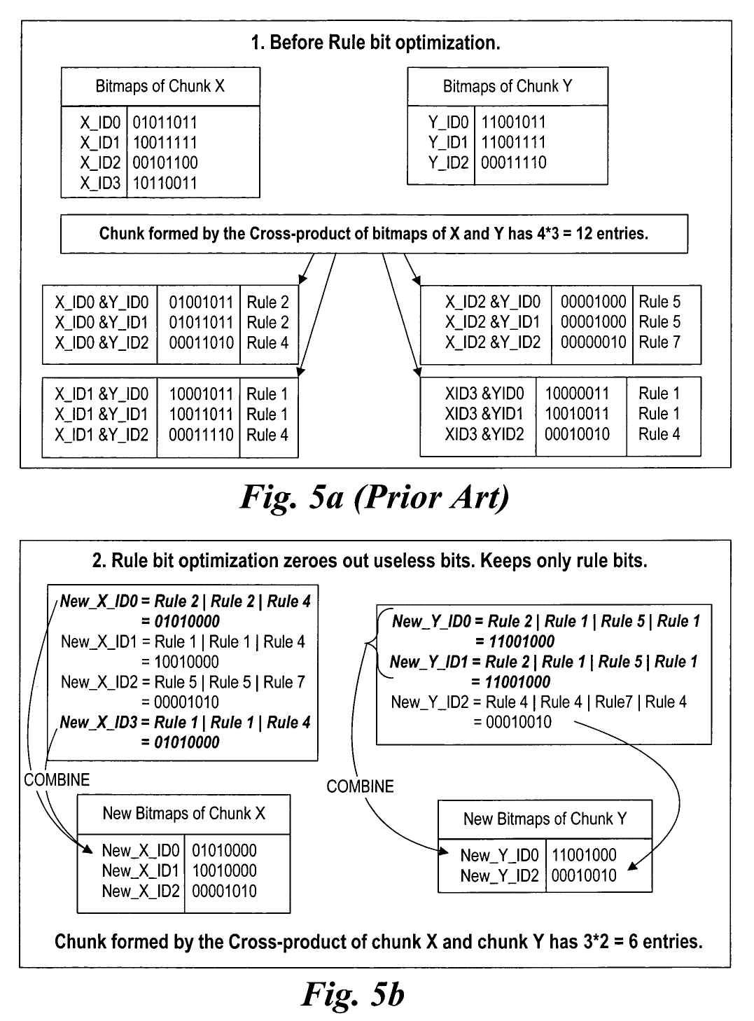

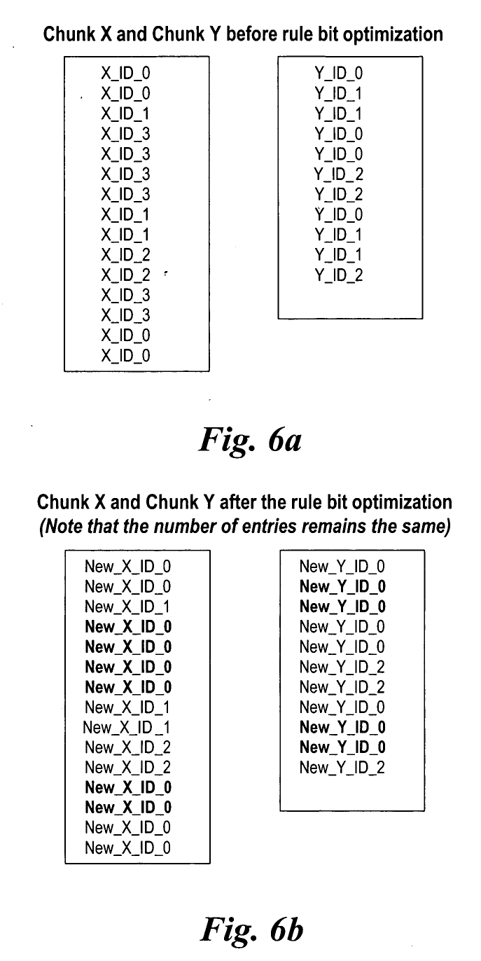

RFC constructs five bit vectors for these three ranges. The reason for this is that when the start and endpoints of these 3 ranges are projected onto a number line, they result in five distinct intervals that each match a different set of rules {(161, 162), (162, 163), (163, 165), (165, 166), (166, 168)}, as schematically depicted in FIG. 4a. RFC constructs a bit vector for each of these five projected ranges (e.g., the five bit vectors would be {100, 110, 111, 011, 001}).

Let us look at another example (ignoring other fields for simplicity). In the foregoing example, RFC produced more bit vectors than BV. In the example shown in Table 3 below, RFC will produce fewer bit vectors than BV. Table 3 shown below depicts a 5-rule database.

TABLE 3

| | | | |
|---|---|---|---|
| Rule 1: | eq www | udp | Ignore other fields for this example |
| Rule 2: | range 20-21 | udp | Ignore other fields for this example |
| Rule 3: | eq www | tcp | Ignore other fields for this example |
| Rule 4: | gt 1023 | tcp | Ignore other fields for this example |
| Rule 5: | gt 1023 | tcp | Ignore other fields for this example |

For this example, there are four unique bit vectors for the destination ports. These are constructed by projecting the ranges onto a number line. These four bit vectors and their corresponding sets are shown below in Table 4. In this instance, all the destination ports in a set share the same bit vector.

TABLE 4

| | |
|---|---|
| {20, 21} | 01000 |
| {1024-65535} | 00011 |
| {80} | 10100 |
| {0-19, 22-79, 81-1023} | 00000. |

Similarly, we have two bit vectors for the protocol field. These correspond to {tcp} and {udp}. Their values are 00111 and 11000.

The previous examples used non-prefix ranges (e.g., port ranges). By non-prefix ranges, we mean ranges that do not begin and end at powers of two (bit boundaries). When prefixes intersect, one of the prefixes has to be completely enclosed in the other. Because of this property of prefixes, the RFC and BV bit vectors for prefixes would be effectively the same. What we mean by “effectively” is illustrated with the following example for prefix ranges shown in Table 5 and schematically depicts in FIG. 4b:

TABLE 5

| Rule# | Prefix | BV bitmap | RFC bitmap |
|---|---|---|---|
| Rule 1: | 202/8 | 100 | Non-existent |
| Rule 2: | 202.128/9 | 110 | 110 |
| Rule 3: | 202.0/9 | 101 | 101 |

The reason the RFC bitmap for 202/8 is non-existent is because it is never going to be used. Suppose we put the three prefixes 202/8, 202.128/9, 202.0/9 into a trie. When we perform a longest match lookup, we are never going to match the /8. This is because both the /9s completely account for the address space of the /8. A longest match lookup is always going to match one of the /9s only. So BV might as well discard the bitmap 100 corresponding to 202/8 since it is never going to be used.

With reference to the 5-rule example shown in Table 3 above, Phase 0 proceeds as follows. There are four unique bit vectors for the destination ports. These are constructed by projecting the ranges onto a number line. These four bit vectors and their corresponding sets are shown below in Table 6, wherein all the destination ports in a set share the same bit vector. Similarly, we have two bit vectors for the protocol field. These correspond to {tcp} and {udp}. Their values are 00111 and 11000.

TABLE 6

| Destination ports | Rule bit vector |
|---|---|
| {20, 21} | 01000 |
| {1024-65535} | 00011 |
| {80} | 10100 |
| {0-19, 22-79, 81-1023} | 00000. |

For the above example, we have four destination port bit vectors and two protocol field bit vectors. Each bit vector is given an ID, with the result depicted in Table 7 below:

TABLE 7

| | Chunk ID | Rule bit vector |
|---|---|---|
| Destination Ports | | |
| {20, 21} | ID 0 | 01000 |
| {1024-65535} | ID 1 | 00011 |
| {80} | ID 2 | 10100 |
| {0-19, 22-79, 81-1023}. | ID 3 | 00000 |
| Protocol | | |
| {tcp} | ID 0 | 00111 |
| {udp} | ID 1 | 11000 |

Recall that the chunks are integer arrays. The destination port chunk is created by making entries 20 and 21 hold the value 0 (due to ID 0). Similarly, entries 1024-65535 of the array (i.e. chunk) hold the value 1, while the 80^{th} element of the array holds the value 2, etc. In this manner, all the chunks for the first phase are created. For the IP address prefixes, we split the 32-bit addresses into two halves, with each half being used to generate a chunk. If the 32-bit address is used as is, a 2ˆ32 sized array would be required. All of the chunks of the first phase have 65536 (64 K) elements except for the protocol chunk, which has 256 elements.

In BV, if we want to combine the protocol field match and the destination port match, we perform an ANDing of the bit vectors. However, RFC does not do this. Instead of ANDing the bit vectors, RFC pre-computes the results of the ANDing. Furthermore, RFC pre-computes all possible ANDings—i.e. it cross-products. RFC accesses these pre-computed results by simple array indexing.

When we cross-product the destination port and the protocol fields, we get the following cross-product array (each of the resulting unique bit vectors again gets an ID) shown in Table 8. This cross-product array is read using an index to find the result of any ANDing.

TABLE 8

| IDs which were cross-producted | | |
|---|---|---|
| (PortID, ProtocolID) | Result | Unique ID |
| (ID 0, ID 0) | 00000 | ID 0 |
| (ID 0, ID 1) | 01000 | ID 1 |
| (ID 1, ID 0) | 00011 | ID 2 |
| (ID 1, ID 1) | 00000 | ID 0 |
| (ID 2, ID 0) | 00100 | ID 3 |
| (ID 2, ID 1) | 10000 | ID 4 |
| (ID 3, ID 0) | 00000 | ID 0 |
| (ID 3, ID 1) | 00000 | ID 0 |

The cross-product array comprises the chunk. The number of entries in a chunk that results from combining the destination port chunk and the protocol chunk is 4*2=8. The four IDs of the destination port chunk are cross-producted with the two IDs of the protocol chunk.

Now, suppose a packet whose destination port is 80 (www) and protocol is TCP is received. RFC uses the destination port number to index into a destination port array with 2ˆ16 elements. Each array element has an ID that corresponds to its array index. For example the 80^{th} element (port www) of the destination port array would have the ID 2. Similarly, since tcp's protocol number is 6, the sixth element of the protocol array would have the ID 0.

After RFC finds the IDs corresponding to the destination port (ID 10) and protocol (ID 0), it uses these IDs to index into the array containing the cross-product results. (ID 2, ID 0) is used to lookup the cross-product array shown above in Table 8, returning ID 3. Thus, by array indexing, the same result is achieved as a conjunction of bit vectors.

Similar operations are performed for each field. This would require that array for the IP addresses to be 2ˆ32 in size. Since this is too large, the source and destination prefixes are looked up in two steps, wherein the 32-bit address is broken up into two 16-bit halves. Each 16-bit half is used to index into a 2ˆ16 sized array. The results of the two 16-bit halves are ANDed to give us a bit vector (ID) for the complete 32-bit address.

If we need to find only the action, the last chunk can store the action instead of a rule index. This saves space because fewer bits are required to encode an action. If there are only two actions (“permit” and “deny”), only one bit is required to encode the action.

The RFC lookup data structure consists only of these chunks (arrays). The drawback of RFC is the huge memory consumption of these arrays. For ACL3 (2200 rules), RFC requires 6.6 MB, as shown in FIG. 3b, wherein the memory storage breakdown is depicted for each chunk.

Aggregated Bit Vectors (ABV)

The Aggregated bit vectors (ABV) algorithm (Florin Baboescu and George Varghese, Scalable Packet Classification, ACM SIGCOMM 2001. seeks to optimize BV when there are a large number of rules. Under this circumstance, BV has the following problems: 1) the memory bandwidth consumed by BV is high: For n rules, the number of bits fetched is 5n; apart from fetching all the BV bits, 2) they have to be ANDed; and 3) the storage grows quadratically.

ABV uses an aggregated bit vector to solve these problems. The aggregated bit vector has a bit set for every k (e.g. 32) bits of the rule bit vector. Whereas the length of the rule bit vectors shown above is equal to the number of rules, the length of the aggregated bit vector is equal to the number of rules divided by k. For example, when k=32, 2040 rules would require an aggregated bit vector that is 64 bits long.

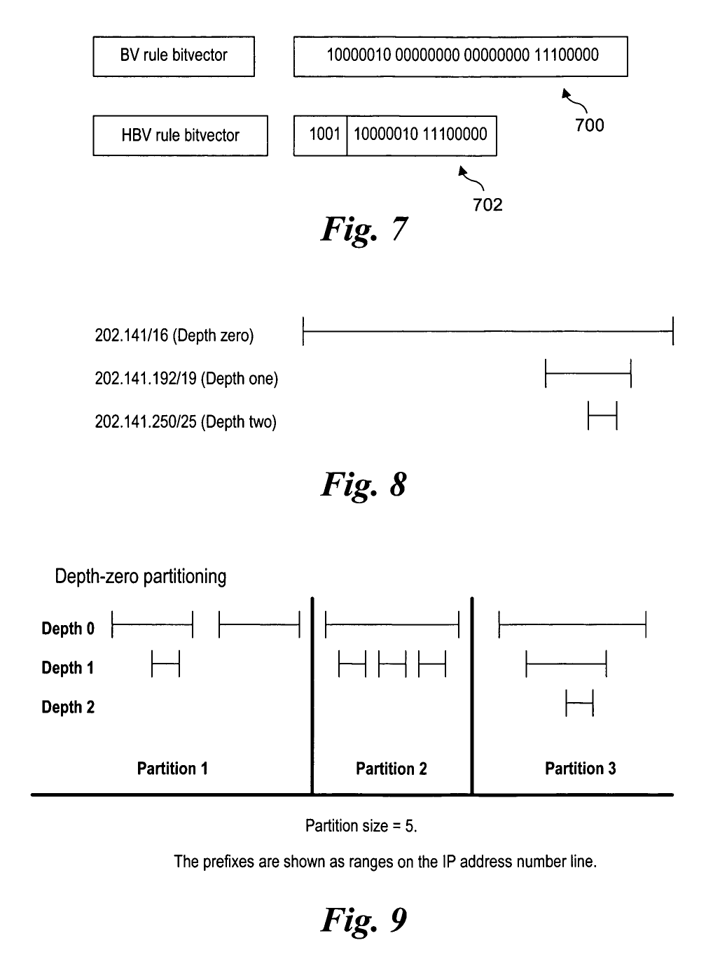

With reference to FIG. 7, suppose we have the following rule bit vector 700 with 32 bits:
100000010 00000000 00000000 11100000.
   If one bit in the aggregated bit vector is stored for every 8 bits, the aggregated bit vector would be: 1001. The second and third bits of the aggregated bitvector are not set because bits 8-15 and 16-23 of the rule bit vector above are all zeros. Along with this, the 8 bits corresponding to each bit set in the aggregated bit vector are also stored. In this case, 10000010 and 11100000 would be stored, while zeros corresponding to the second and third bytes are not be stored. This result is depicted by aggregated bit vector 702.

By ANDing the aggregated bitvectors, a determination can be made to which bits in the longer rule bit vectors need to be ANDed. This saves memory.

The lookup process for ABV is now slightly different. Before the bit vectors are ANDed, their summaries are ANDed. By using the set bits in the ANDed summary, only those parts of the bit vectors that we really need to find the matching rule are fetched. This reduces the number of memory accesses and the memory bandwidth consumed.

ACLs contain several rules that have a * (don't care) in one or more fields. All the bits corresponding to don't cares are going to be set. However, rather than storing these don't care rule bits in every rule bit vector, the bits for don't care rules can be stored on chip. These don't care bits can then be ORed with the bitvector that is fetched from memory.

In accordance with aspects of the embodiments of the invention describe below, optimizations are now disclosed that significantly reduce the memory consumption problem associated with the conventional RFC and ABV schemes.

Partitioned Bit Vector

Under the foregoing technique using RFC chunks, bitvectors may be fetched using two dependent memory accesses. However, this still may present problems with respect to memory bandwidth and memory accesses (due to false matches).

False match refers to the following phenomenon: ANDing of the aggregated bit vector results in set bits that indicate a match. However, when the lower level bit vectors corresponding to these set bits are ANDed, there may be no actual match. For example, suppose 10 and 11 are aggregate bit vectors for 10000000 and 01000001. Each bit in the aggregated bit vector represents four bits in the lower level bit vector. ANDing of the aggregated bit vectors yields 10. This leads us to fetch the first four bits of the lower level bit vectors. These are 1000 and 0100. When we AND these, we get 0000. This is a false match.

In order to reduce false matches, ABV uses sorting of rules by prefix length. Though this reduces the number of false matches, the number is still high. For two ACLs that we tested this on, despite sorting, in the worst case, 11 and 17 bits can be set in the ANDed aggregated bit vectors for the two ACLs respectively. Partitioning reduces this to just 2 set bits. Each set bit requires 5 memory accesses for fetching from the lower level bit vectors in each of 5 dimensions. So partitioning results in a sharp decrease in memory accesses and memory bandwidth.

Due to sorting, at lookup time, ABV finds all matches and remaps them. It then takes the highest priority rule from among the remapped rules. For an exemplary ACL, in the worst case, this would result in more than 30 unnecessary memory accesses.

The bitvectors can be quite long for a large number of rules, resulting in large memory bandwidth consumption. Without hardware support, ANDing of aggregated bit vectors in software results in extra memory accesses due to false matches. These memory accesses are required to retrieve bits from the lower level bitvector whenever a one (or set bit) is detected in the aggregate bit vector. Both of these problems may be solved by an embodiment of the invention called the Partitioned Bit Vector algorithm, also referred to as the partitioning algorithm.

The partitioned bit vector algorithm divides the database into several partitions. Each partition contains a small number of rules. With partitioning, rather than searching all the rules, only a few partitions need to be searched. In general, partitioning can be implemented for a bit vector algorithm based on tries or RFC chunks.

The observation on which partitioning is based is that, for a given packet there are only a small number of candidate rules—only the bits corresponding to these rules need to be fetched instead of the entire rule bitvector. For example, if the source prefix is identified, only the bits for rules that are compatible with the matched source prefix need to be fetched. If we go further and identify the destination prefix, we need to fetch only the bits corresponding to this source and destination prefix pair.

Suppose a 2000 rule database is employed, which includes 10 rules with 202 as the first source IP octet and 5 rules with * in the source IP prefix field. If a packet with the source IP address starting with 202 is received, only these 10+5=15 rules need to be considered, and thus fetched. Under the conventional bit vector algorithm, the entire bitvector, which can potentially contain bits for all 2000 rules, would be retrieved.

The list of partitions into which a database is divided is called a partitioning. In one embodiment, the size of a partition is relatively small (e.g., 32-128 rules). The lookup process now consists of two steps. In the first step, the partitions to be searched are identified. In the second step, the partitions are searched to find the highest-priority matching rule.

Table 9 shows a simple partitioning example that employs an ACL with 8 rules.

TABLE 9

| Rule No. | Src. IP | Dst. IP | Src. Port | Dst. Port | Protocol |
|---|---|---|---|---|---|
| 1 | * | * | * | 22 | TCP |
| 2 | * | 100.10/16 | * | 32 | UDP |
| 3 | 8.8.8.8 | 101.2.0.0 | * | * | TCP |
| 4 | 12.2.3.4 | 202.12.4.5 | * | 4352 | TCP |
| 5 | 12.61.0/24 | 106.3.4.5 | * | 8796 | TCP |
| 6 | 12.61.0/24 | 3.3.3.3 | 14 | 3 | UDP |
| 7 | 150.10.6.16 | 2.2.2.2 | 12 | 4 | TCP |
| 8 | 200.200/16 | * | * | 8756 | TCP |

Suppose the partition size is two (i.e., each partition includes two rules). If the source IP field is partitioned, the following partitioning of the ACL results.

TABLE 10
Partitioning-1

| Par- | | | | | | |
|---|---|---|---|---|---|---|
| ti- | | | | | | |
| tion | | | S. | D. | | |
| No. | Source IP | DstIP | port | port | Prot. | Rules |
| 1 | 0.0.0.0-255.255.255.255 | * | * | * | * | 1, 2 |
| 2 | 8.8.8.8-12.60.255.255 | * | * | * | * | 3, 4 |
| 3 | 12.61.0.0-12.61.255.255 | * | * | * | * | 5, 6 |
| 4 | 150.10.6.16-200.200.255.255 | * | * | * | * | 7, 8 |

The partition bit vectors for the Source IP prefixes would be as follows:

TABLE 11

| Source IP | Partition | Rule |
|---|---|---|
| address prefix | bit vector | bit vector |
| * | 1000 | 11 00 00 00 |
| 8.8.8.8 | 1100 | 11 10 00 00 |
| 12.2.3.4 | 1101 | 11 01 00 00 |
| 12.61.0/24 | 1010 | 11 00 11 00 |
| 150.10.6.16 | 1001 | 11 00 00 10 |
| 200.200.0.0/16 | 1001 | 11 00 00 01 |

The foregoing example illustrated a simplified form of partitioning. For a real ACL (with much larger number of rules), partitioning may need to be performed on multiple fields or at multiple “depths.” Rules may also be replicated. A larger example is presented below.

For example, for a larger partition size the rules in partition 1 may be replicated into the other partitions. This would make it necessary to search only one partition during lookup. With the foregoing partitioning (Partitioning-1), two partitions need to be searched for every packet. If the rules in partition 1 are copied into all the other 3 partitions, then only one partition needs to be searched during the lookup step, as illustrated by the Partitioning-2 example shown below.

We need to set only one bit for the partition bit vector of *. It is unnecessary to look up all 3 partitions when * is the longest matching source prefix. Similarly, we also use the minimal number of partitions for the other prefixes.

TABLE 12
Partitioning-2 (consists of 3 partitions)

| Par- | | | | | | |
|---|---|---|---|---|---|---|
| ti- | | | | | | |
| tion | | | S. | D. | | |
| No. | Source IP | DstIP | port | port | Prot. | Rules |
| 1 | 0.0.0.0-12.60.255.255 | * | * | * | * | 1, 2, |
| | | | | | | 3, 4 |
| 2 | 12.61.0.0-150.10.6.15 | * | * | * | * | 1, 2, |
| | | | | | | 5, 6 |
| 3 | 150.10.6.16-255.255.255.255 | * | * | * | * | 1, 2, |
| | | | | | | 7, 8 |

| Source IP address prefix | Partition bit vector | Rule bit vector |
|---|---|---|
| * | 100 | 1100 1100 1100 |
| 8.8.8.8 | 100 | 1110 1100 1100 |
| 12.2.3.4 | 100 | 1111 1100 1100 |
| 12.61.0/24 | 010 | 1100 1111 1100 |
| 150.10.6.16 | 001 | 1100 1100 1110 |
| 200.200.0.0/16 | 001 | 1100 1100 1111 |

The rule bit vector has 12 bits even though the ACL has only 8 rules. This is because there are 3 partitions and each partition can hold 4 rules. Therefore the rule bit vector represents 3*4=12 possible rules.

The Peeling Algorithm: Depth-Wise Partitioning

In the previous example, we saw two possible ways of partitioning the ACL (partition-1 and partition-2). We will now generalize the method used to arrive at those partitions. Partitioning is introduced through pseudocode and a series of definitions.

Definition 1: Prefix Depth

The first definition is the term “depth” of a prefix. The depth of a prefix is the number of less specific prefixes the prefix encapsulates. A source prefix is said to be of depth zero if it has no less specific source prefixes in the database. Similarly, a destination prefix is said to be of depth zero if it has no less specific destination prefixes in the database. More particularly, a source prefix is said to be of depth x if it has exactly x less specific source prefixes in the database. Similarly, a destination prefix is said to be of depth x if it has exactly x less specific destination prefixes in the database. In example of a set of prefixes and associated depths is shown in FIG. 8.

Definition 2: Depth-Zero Partitioning and All-Depth Partitioning

Prefixes are a special category of ranges. When two prefixes intersect, one of them completely overlaps the other. However, this is not true for all ranges. For example, although the ranges (161, 165) and (163, 167) intersect, neither of them overlaps the other completely. Port ranges are non-prefix ranges, and need not overlap completely when intersecting. For such ranges, there is no concept of depth

As a consequence of this, we may be able to partition more efficiently along the source and destination IP prefix fields compared to partitioning along port ranges. We use the concept of depth to partition along the IP prefix fields. This method of partitioning is called depth zero partitioning. When we partition along the port ranges, we make use of all-depth partitioning. All-depth partitioning results in cutting of ranges; such cutting necessitates replication of rules.

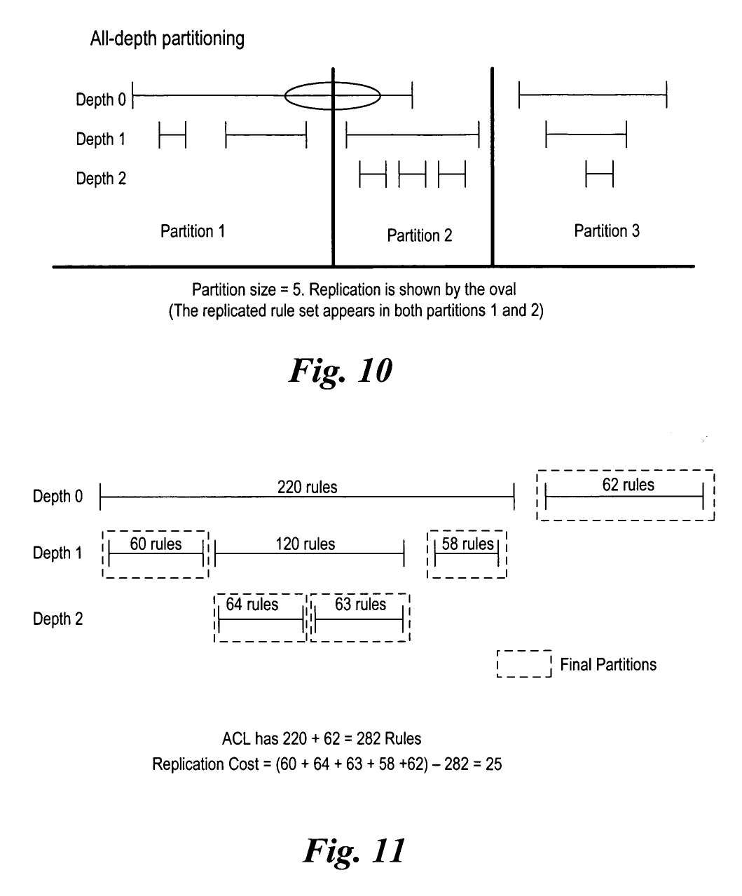

An example of depth-zero partitioning is illustrated in FIG. 9, while an example of all-depth partitioning is illustrated in FIG. 10.

Definition 3: The Partition Data Structure—What Constitutes a Partition?

A partition consists of:
1. A meta-rule: For each dimension d, a start-point and an end-point. This set of start-points and end-points will henceforth be called the meta-rule of the partition. For example, the meta-rule of the second partition in partitioning-1 of Table 10 is [0.0.0.0-12.60.255.255, *, *, *, *].
2. A list of rules LR. LR consists of ACL rules that intersect the meta-rule. (i.e., an LR contains rules that can potentially be matched by a packet that satisfies the start-points and end-points in all dimensions). For example, the LR of the second partition in partitioning-1 is {3, 4}.
   Definition 4: Types of Partitions

There are two types of partitions:
1. Unshared partition. Contains at least one rule in its LR that do not intersect with the meta-rule of any other partition. For example, Partitions 2, 3 and 4 in the Partitioning-1 shown in Table 10.
2. Shared partition. All rules in the LR of a shared partition intersect with the meta-rules of at least two unshared partitions. Shared partitions are constructed using covering ranges (defined below). For example, Partition 1 in the Partitioning-1 shown in Table 10 is a shared partition. The covering range is 0.0.0.0-255.255.255.255.
   Definition 5: Covering Range

A covering range is used in depth zero partitioning. A range p is said to cover a range q, if q is a subset of p: e.g., p=202/7, q=203/8 or p=* and q=gt 1023. Each list of partitions may have a covering range. The covering range of a partition is a prefix/range belonging to one of the rules of the partition. A prefix/range is called a covering range if it covers all the rules in the same dimension. For example, * (0.0.0.0-255.255.255.255) is the covering range in the source prefix field for the ACL of the foregoing example.

Definition 6: Peeling

Peeling refers to the removal of the covering range from the list of ranges. When the covering range of a list of ranges is removed (provided the covering range exists), a new depth of ranges get exposed. The covering range prevented the ranges it had covered from being subjected to depth zero partitioning. By removing the covering range, the covered ranges are brought to the surface. These newly exposed ranges can then be subjected to depth zero partitioning.

An exemplary implementation of peeling is shown in FIG. 11. At depth 0, the ACL has 282 rules, which includes 240 rules in a first partition and 62 rules in a second partition. However, the first partition has a covering range of various depth 1 ranges. Additionally, the 120 rule range at depth 1 is a covering range of each of the 64 rule and 63 rule ranges at depth 2. By “peeling” the 120 rule covering range a depth 1, and then peeling the 240 rule covering range at depth 0, we are left with the various ranges shown in the dashed boxes. These are the ranges used to define the final partitions, which now include five partitions.

Definition 7: Rule-Map

At the end of partitioning, we are left with some number of partitions, each partition having some number of rules. The number of rules in each partition is less than the maximum partition size. Let us assume that the rules within each partition are sorted in order of priority. (As used herein, “priority” is used synonymously with “rule index”.) Due to replication, the total number of rules in all the partitions combined can be greater than the number of rules in the ACL.

The partitioning is used by a bit vector algorithm for lookup. This bit vector algorithm assigns a pseudo rule index to each rule in the partitioning. These pseudo rule indices are then mapped back to true rule indices in order to find the highest priority matching rule during the run-time phase. This mapping process is done using an array called a rule-map.

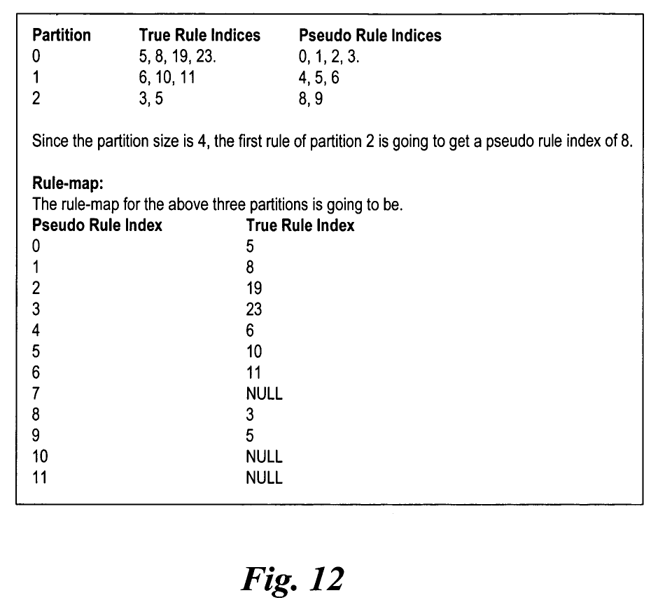

An exemplary rule map is illustrated in FIG. 12. This rule map has a partition size of 4. The pseudo rule index for a given partition is determined by the partition number times the partition size, plus an offset from the start of the partition. For example, the pseudo rule index for rule 8, which is the second (position 1) rule in partition 0 is:
Pseudo Rule Index for Rule 8=0*4+1=1
while the pseudo rule index for rule 3, which is the first (position 0) rule in partition 2 is:
Pseudo Rule Index for Rule 3=2*4+0=8
Definition 8: Pruning

Pruning is an important optimization. When partitioning is implemented using a different dimension rather than going one more depth into the same dimension, pruning provides an advantage. For example, suppose partitioning is performed along the source prefix the first time. Also suppose * is the covering range and * has associated with it 40 rules. Further suppose the maximum partition size is 64. In this instance, replicating 40 rules does not make good sense—there is too much of wastage. Therefore, rather than replicate the covering range, a separate partition is kept that needs to be considered for all packets.

Suppose it turns out that the partitioning along the source prefix is not enough, and there is a partition with 80 rules due to a source prefix 202.141.80/24 (i.e. there are 80 rules that match source prefix 202.141.80/24 in the source dimension). Also suppose that 42 of these 80 rules have 202.141.80/24 as the source prefix. Now, if we go one more depth into source prefix, 202.141.80/24 is going to be the covering range. This covering range is costly to replicate (it comes with 42 rules). We now have two common partitions with a total of 82 rules (40 (due to *)+42 (202.141.80/24)). This additional partition along the source prefix means that there may be a need to search up to three partitions for some packets.

Therefore, a better option is to use the destination prefix to partition the 80 rules that match source prefix 202.141.80/24 in the source dimension, along with pruning. When we partition along the destination prefix, the observation is that, of the 40 common rules that were inherited due to source prefix=*, we need to retain only those rules which match the partitions in both dimensions. That is, by partitioning along the destination prefix, we now have partitions that are described by a prefix-pair. This partition needs to store only those rules that are compatible with this prefix pair; others can be removed.

Thus pruning can remove many of the 40 common rules that were inherited due to source prefix=*. After pruning, it may turn out that those rules with source prefix=* that are compatible with a partition's prefix-pair are few enough that they can be replicated. When this is done, there is no need to visit the * partition for those packets which match this prefix-pair.

When partitioning along the destination prefix, we may also get some common rules due to destination prefix=*. Such rules can also be pruned using the source prefix of the partition's prefix-pair. However, even without this pruning optimization, partitioning requires at most 2 partitions to be searched for the example ACLs the algorithm has been tested on.

Definition 9: Partitioned Bit Vector=Partitioning+Bit Vector Algorithm

Now that we have an intuitive understanding of partitioning, let us use the partitioned ACL in a bit vector algorithm. This scheme employs two kinds of bitvectors:
1. Rule bitvectors: The rule bitvectors are used to identify the matching rule. Each rule bitvector has one bit for each rule in the partitioning (constructed using the pseudo rule indices).
2. Partition bitvectors: The partition bitvectors are used to identify the partitions that have to be searched. A partition bitvector has one bit for each partition of the database.
   Detailed Example of the Partitioned Bit Vector Scheme

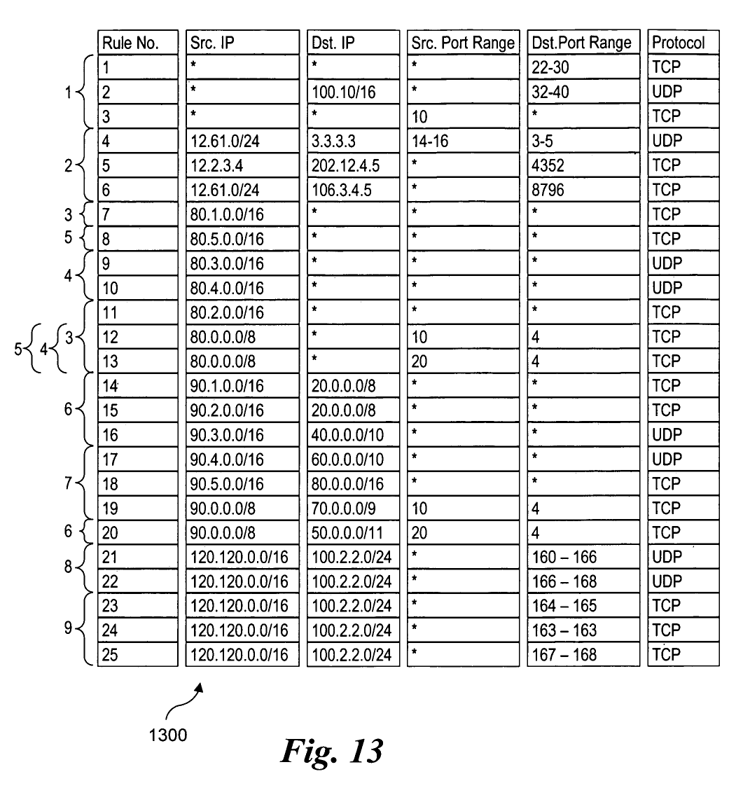

The following provides a detailed discussion of an exemplary implementation of the partitioned bit vector scheme. The exemplary implementation employs a 25-rule ACL 1300 depicted in FIG. 13. For illustrative purposes, it is presumed that the maximum partition size is 4 rules. As the scheme is fully scalable, similar techniques may be employed to support existing and future ACL databases with 1000's of rules or more.

An implementation of the partitioned bit vector scheme includes two primary phases: 1) the build phase, during which the data structures are defined and populated; and 2) the run-time lookup phase. The build phase begins with determining how the ACL is to be partitioned. For ACL 1300, the partitioning steps are as follows:
1. Suppose we decide to partition along the Source IP field. First, the depth zero Src. IP prefixes are extracted. The only depth zero prefix is *.*, which is the covering range here because it covers all rules being partitioned in the Src. IP field.
2. We now find the number of rules associated with *. There are three of them (Rules 1, 2 and 3). From above, the maximum partition size=4 rules.
   a. If we replicate rules with Src. IP=* in every partition, 75% (¾) of the resulting data would require replication. This is very inefficient.
   b. Accordingly, we decide to keep rules with Src. IP=* in a separate partition. The penalty for this is this partition will need to be searched by every packet.
      i. The first partition is thus defined by metarule [*, *, *, *, *], and includes 3 rules (Rules 1, 2 and 3).

Having dealt with Src. IP=*, let us now partition the remaining rules. Suppose we look at the Src. IP field again (since a * value in the Dest. IP field maps to a number of rules, the Dest. IP field is not a good candidate for partitioning). Among the remaining rules (Rules 4-25), let us find the depth zero Src. IP prefixes and the number of rules covered by each.

These are: 12.2.3.4 covering one rule (Rule 5)
12.61.0/24 covering two rules (Rules 4, 6)
80.0.0.0/8 covering seven rules (Rules 7-13)
90.0.0.0/8 covering seven rules (Rules 14-20)
120.120.0.0/16 covering five rules (Rules 21-25).

Since the other fields were not promising, partitioning using Src. IP prefixes selected. A partitioning corresponding to the foregoing Src. IP prefixes includes the following partitions:

[12.2.3.4-12.61.0.0/24, *, *, *, *] has three rules (Rules 4, 5 and 6).

[80.0.0.0/8, *, *, *, *] has seven rules (Rules 7-13).

[90.0.0.0/8, *, *, *, *] has seven rules (Rules 14-20).

[120.120.0.0/16*, *, *, *] has five rules (Rules 21-25).

Although the rules in each partition are contiguous (by coincidence), the existence or lack of continuity for the rules corresponding to the partitions is irrelevant.

In view of the foregoing 4-rule limitation, three of the four partitions are too big. As a result, further partitioning is required. An exemplary partitioning is presented below.

We begin by sub-partitioning the [80.0.0.0-89.255.255.255, *, *, *, *] Src. IP prefix range, which has seven rules (Rules 7-13). It is observed that 80.0.0.0/8 is a covering range for all of these seven rules. There are two rules with Src. IP=80.0.0.0/8 (Rules 12 and 13). All the seven rules have Dest. IP=*, so pruning is unavailable. Accordingly, we select to peel off 80.0.0.0/8, which results in the following depth zero prefixes and the number of rules covered by each:
80.1.0.0/16 covering one rule (Rule 7).
80.2.0.0/16 covering one rule (Rule 11).
80.3.0.0/16 covering one rule (Rule 9).
80.4.0.0/16 covering one rule (Rule 10).
80.5.0.0/16 covering one rule (Rule 8).
   This situation is easily partitionable.

A home for Rules 12 and 13 (the rules associated with the covering range 80.0.0.0/8 that were peeled off) also needs to be found. This can be accomplished by either creating a separate partition for Rules 12 and 13 (increasing the number of partitions to be searched during lookup time) or these rules can be replicated (with an associated cost of 50% in the restricted rule set of Rules 7-13). Replication is thus selected, since it results in a better space-time tradeoff.

This gives us the following partitions:
[80.0.0.0-80.2.255.255, *, *, *, *] with 4 rules (Rules 7, 11, 12, 13).
[80.3.0.0-80.4.255.255, *, *, *, *] with 4 rules (Rules 9, 10, 12, 13).
[80.5.0.0/16, *, *, *, *] with 4 rules (Rules 8, 12, 13).

Next, [90.0.0.0/8, *, *, *, *] Src. IP prefix range is addressed, which has seven rules (Rules 14-20). The covering range is 90.0.0.0/8 and there are two rules with this Src. IP prefix (Rules 19 and 20). If we partition along the Src. IP prefix by peeling away 90.0.0.0/8, we would have to replicate rules 19 and 20. However, employing pruning would be more beneficial than peeling in this instance.

If we look at the Dest. IP field (for Rules 14-20), the depth zero prefixes are:
20.0.0.0/8 covering two rules (Rule 14, 15).
40.0.0.0/10 covering one rule (Rule 16).
50.0.0.0/11 covering one rule (Rule 20).
60.0.0.0/10 covering one rule (Rule 17).
70.0.0.0/9 covering one rule (Rule 19).
80.0.0.0/16 covering one rule (Rule 18).

This is easily partitionable, resulting in the following partitions:

[90.0.0.0/8, 20.0.0.0-50.224.255.255, *, *, *] with 4 rules (Rules 14, 15, 16, 20).

[90.0.0.0/8, 60.192.0.0-80.0.255.255, *, *, *] with 3 rules (Rules 17, 19, 18).

Continuing with the present example, now we consider the Src. IP prefix range [120.120.0.0/16, *, *, *, *], which has five rules (Rules 21-25). The values in Src. IP, Dest. IP and Src. Port fields are all the same. Thus, these fields do not provide values to partition on. Accordingly, we can partition only along the remaining two fields—Dest. Port and Protocol.

Since Dest. Port and Protocol fields are non-prefix fields, there is no concept of a depth zero prefix. In addition, Dest. Port ranges can intersect arbitrarily. As a result, we just have to cut the Dest. Port range without any notion of depth. The best partition along the Dest. Port range that would minimize replication would be (160-165) and (166-168), which requires only rule 21 be replicated. The applicable cutting point (165) is identified by a simple linear search.

However, partitioning along the protocol field will not require any replication Although partitioning along the destination port would yield the same number of partitions in the present example, partitioning along the protocol field is selected, resulting in the following partitions:
[120.120.0.0/16, 100.2.2.0/14, *, *, UDP] with 2 rules (Rules 21 and 22).
[120.120.0.0/16, 100.2.2.0/14, *, *, TCP] with 3 rules (Rules 23 , 24 and 25).

This completes the partitioning of ACL 1300, with the number of rules in each partition being <=4. The final partitions are:

1. [*, *, *, *, *] with 3 rules (Rules 1, 2 and 3).

2. [12.2.3.4-12.61.0.0/24, *, *, *, *] has three rules (Rules 4, 5 and 6).

3. [80.0.0.0-80.2.255.255, *, *, *, *] with 4 rules (Rules 7, 11, 12, 13).

4. [80.3.0.0-80.4.255.255, *, *, *, *] with 4 rules (Rules 9, 10, 12, 13).

5. [80.5.0.0/16, *, *, *, *] with 4 rules (Rules 8, 12, 13).

6. [90/8, 20.0.0.0-50.0.0.0/11, *, *, *] with 4 rules (Rules 14, 15, 16, 20).

7. [90/8, 60.0.0.0/10-80.0.255.255, *, *, *] with 3 rules (Rules 17, 19, 18).

8. [120.120.0.0/16, 100.2.2.0/24, *, *, *, UDP] with 2 rules (Rules 21 and 22).

9. [120.120.0.0/16, 100.2.2.0/24, *, *, *, TCP] with 3 rules (Rules 23, 24 and 25).

Under this partitioning scheme, only two partitions need to be searched for any packet (partition 1 and some other partition).

Creation of Rule-Map

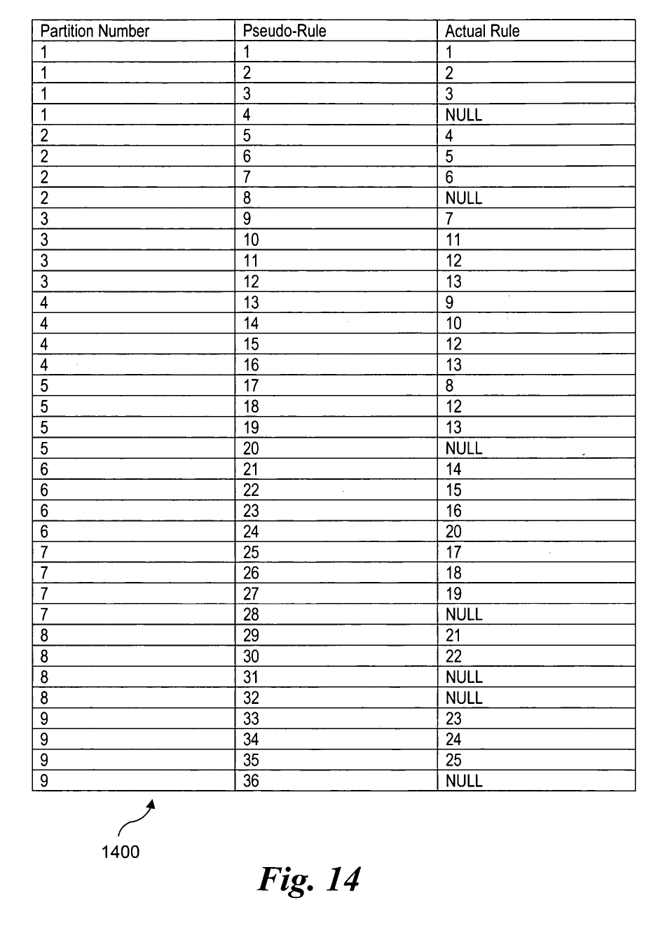

The foregoing portioning produced a total of 9 partitions. Since the maximum size of each partition is 4, the rule-map lookup scheme dictates that the rule-map table include 9*4=36 pseudo-rules, as shown by a rule-map table 1400 in FIG. 14. In addition, the rules in each partition are sorted according to priority, with the highest priority rule on top. By sorting them according to priority, we can take the left-most bit of the bit vector of a partition to be the highest priority matching rule of that partition.

Build Phase

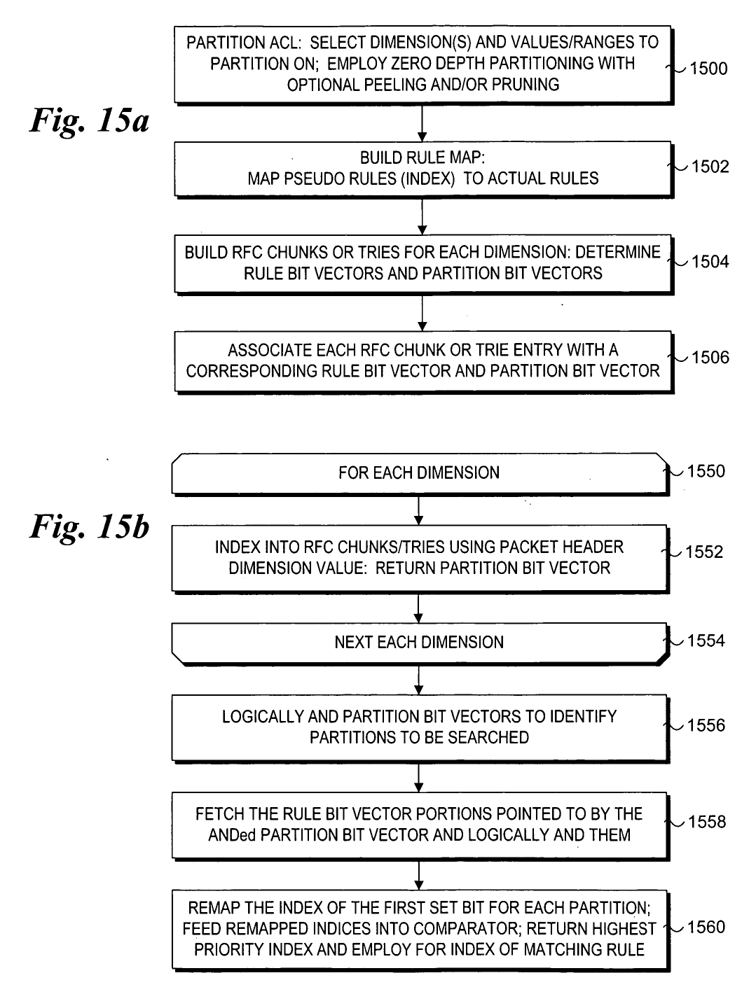

A typical implementation of the partitioned bit vector scheme involves two phases: the build phase, and the run-time lookup phase. During the build phase, a partitioning scheme is selected, and corresponding data structures are built. In further detail, operations performed during one embodiment of the build phase are shown in FIG. 15a.

The process begins in a block 1500 by partitioning the ACL. The foregoing partitioning example is illustrative of typical partitioning operations. In general, partitioning operations include selecting the maximum partition size and selecting the dimensions and ranges and/or values to partition on. Depending on the particular rule set and partitioning parameters, either zero depth partitioning may be implemented, or a combination of zero depth partitioning with peeling and/or pruning may need to employed. In conjunction with performing the partitioning operations, a corresponding rule map is built in a block 1502.

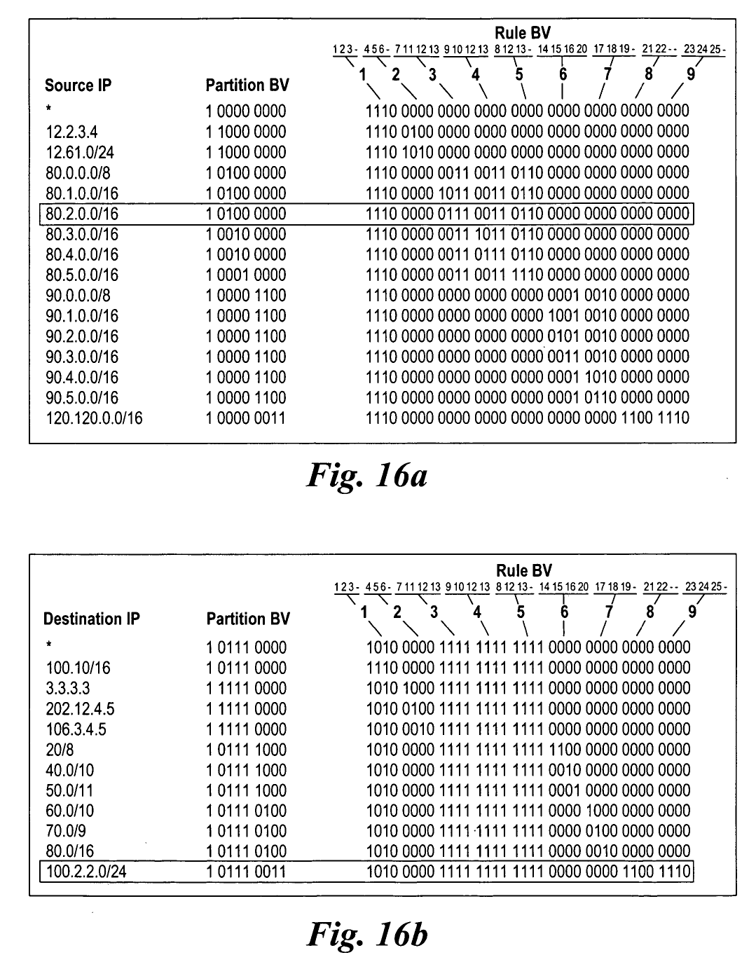

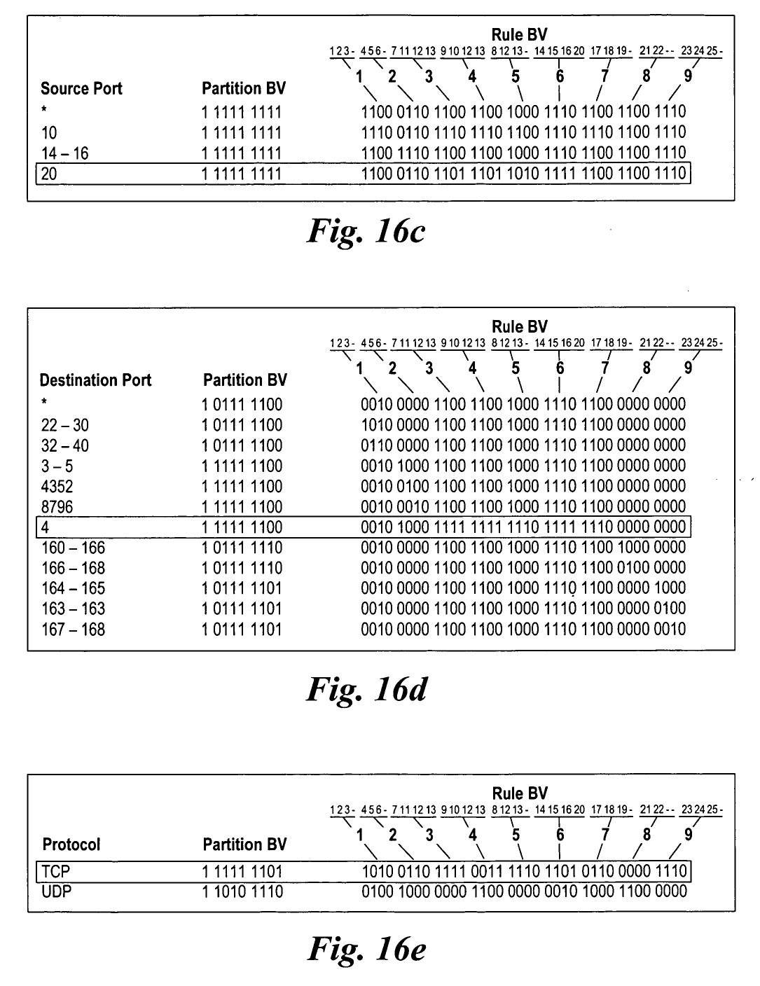

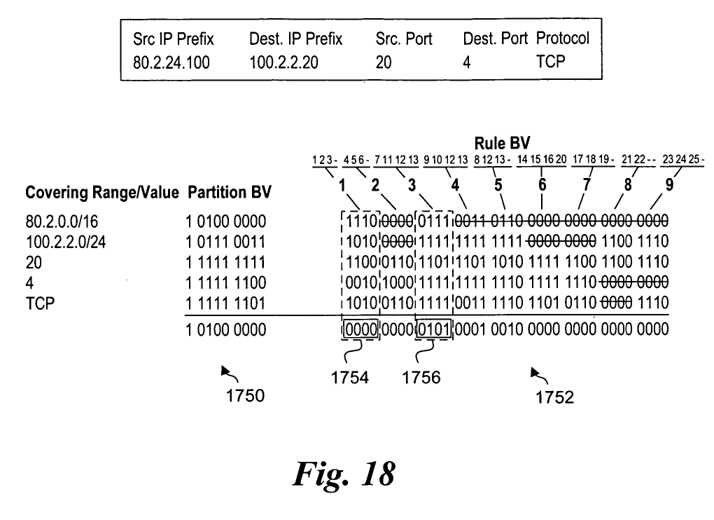

In a block 1504, applicable RFC chunks or tries are built for each dimension (to be employed during the run-time lookup phase). This operation includes the derivation of rule bit vectors and partition bit vectors. An exemplary set of rule bit vectors and partition vectors for Src. IP prefix, Dest. IP prefix, Src Port Range, Dest. Port Range, and Protocol dimensions are respectively shown in FIGS. 16a-e. (It is noted that the example entries in each of FIGS. 16a-e show original rule bit vectors for illustrative purposes; as described below and shown in FIG. 18, only portions of the original rule bit vectors defined by the corresponding partition bit vector for a given entry are stored for that entry.) Also during this time, each entry in each RFC chunk or trie (as applicable) is associated with a corresponding rule bit vector and partition bit vector, as depicted in a block 1506. In one embodiment, pointers are used to provide the associations.

Run-Time Lookup Phase

With reference to the flowchart of FIG. 15b, the partition bit vector lookup process proceeds as follows. First, as depicted by start and end loop blocks 1550 and 1554, and block 1552, the RFC chunks (or tries, whichever is applicable) for each dimension are indexed into using the packet header values. This returns n partition bit vectors, where n identifies the number of dimensions. In accordance with the exemplary partitioning depicted in FIGS. 16a-e, this yields five partition bit vectors. It is noted that for simplicity, the Src. IP and Dest. IP prefixes are not divided into 16-bit halves for this example—in an actual implementation, it would be advisable to perform splitting along these dimensions in a manner similar to that discussed above with reference to the RFC implementation of FIG. 3a.

Next, in a block 1556, the partition bit vectors are logically ANDed to identify the applicable partition(s) that need to be searched. For each partition that is identified, a corresponding portion of the rule bit vectors pointed by each respective partition bit vector are fetched, and then logically ANDed, as depicted by a block 1558. The index of the first set bit for each partition is then remapped in a block 1560, and the remapped indices are fed into a comparator. The comparator then returns the highest priority index and employs the index to identify the matching rule.

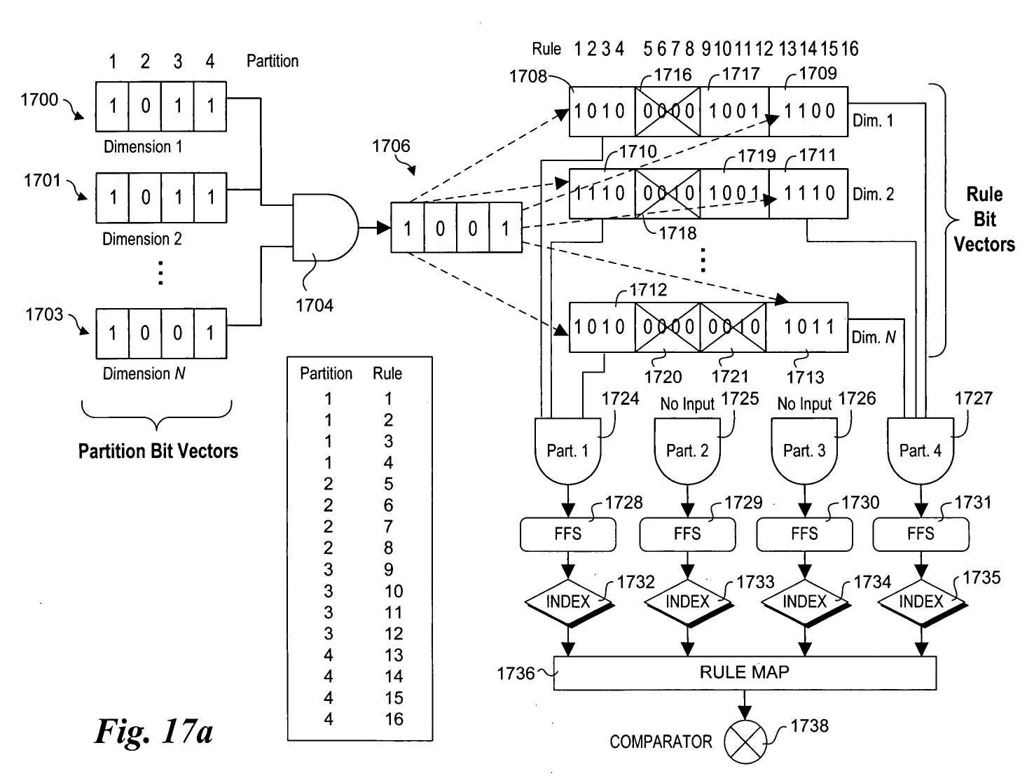

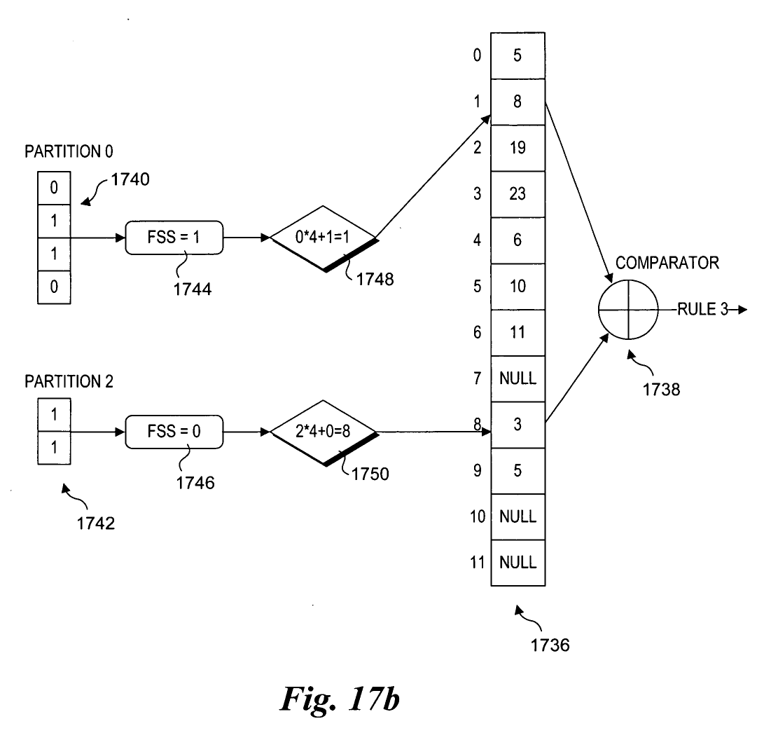

The foregoing process is schematically illustrated in FIGS. 17a and 17b. In this example, we start out with a partition bit vectors 1700, 1701, 1702, corresponding to dimensions 1, 2 and N, respectively, wherein a ACL having 16 rules and N dimensions is partitioned into 4 partitions. For illustrative purposes, there are 4 rules in each partition in the example of FIG. 17a, and the rules are partitioned sequentially in sets of four. (In contrast, as illustrated by partitioning 1300, the number of rules in a partition may vary (but must always be less than or equal to the maximum partition size). Furthermore, the rules need not be partitioned in a sequential order.) The respective bits of these partition bit vectors are logically ANDed (as depicted by an AND gate 1704) to produce an ANDed partitioned bit vector 1706. The set bits in this ANDed partitioned bit vector are then used to identify applicable rule bit vector portions 1708 and 1709 for dimension 1, rule bit vector portions 1710 and 1711 for dimension 2, and rule bit vector portions 1712 and 1713 for dimension 3. Meanwhile, the rule bit vector portions 1716, 1717, 1718, 1919, 1720 and 1721 are ignored, since the two middle bits of ANDed partitioned bit vector 1706 are not set (e.g., =‘0’).

In further detail, under the partitioned bit vector storage scheme for rule bit vectors, if the partition bit in a partition bit vector for a given entry is not set, there is no need to keep the portion of that rule bit vector corresponding to that partition bit. As a result, the rule bit vector portions 1716, 1718, 1720, and 1721 are never stored in the first place, but are merely depicted to illustrate the configuration of the entire original rule bit vectors before the applicable rule bit vector portions for each entry are stored.

In the example of FIG. 17a, the rule bit vector portions corresponding to the rules of partition 1 (e.g., rule bit vector portions 1708, 1710 and 1712, as well as other rule bit vector portions for dimension 3 through N−1, which are not shown) are logically ANDed together, as depicted by an AND gate 1724. Similarly, the rule bit vector portions corresponding to the rules of partition 4 (e.g., rule bit vector portions 1709, 1711 and 1713, as well as other rule bit vector portions for dimension 3 through N−1) are logically ANDed together, as depicted by an AND gate 1727. In addition, there are respective AND gates 1725 and 1726 that receive no input, since the partition bits corresponding to partitions 2 and 3 are not set in ANDed partition bit vector 1706.

The resulting ANDed outputs from AND gates 1724 and 1727 are respectively fed into FFS blocks 1728 and 1731. (Similarly, the ANDed outputs for AND gates 1729 and 1730, if they existed, would be fed into FFS blocks 1729 and 1730). The FFS blocks identify a first set bit for ANDed result of each applicable partition. A respective pseudo rule index is then calculated using the respective outputs of FFS blocks 1728 and 1731, as depicted by index decision blocks 1732 and 1734. (Similar index decision blocks 1733 and 1734 are coupled to receive the outputs of FFS blocks 1729 and 1730, respectively.) The resulting pseudo rule indexes are then input into a rule map 1736 to map each pseudo rule index value to its respective true rule index. The true rule indices are then compared by a comparator 1738 to determine which rule has the highest priority. This rule is then applied for forwarding the packet from which the original dimension values were obtained.

As discussed above, the example of FIG. 17a includes 4 rules for each of 4 partitions, with the rules being mapped to sequential sets. While this provides an easier to follow example of the operation of the partition bit vector scheme, it does not illustrate the necessity or advantage in employing a rule map. Accordingly, the example of FIG. 17b employs the partitioning scheme and rule map of FIG. 12.

In the example of FIG. 17b, the results of the ANDed rule bit vector portions produces an ANDed result 1740 for partition 0 and an ANDed result 1742 for partition 2. ANDed result 1740 is fed into an FFS block 1744, which outputs a 1 (i.e., the first bit set is bit position 1, the second bit for ANDed result 1740). Similarly, ANDed result 1742 is fed into FFS block 1746, which outputs a 0 (the first bit is the first bit set).

The pseudo rule index is determined for each FFS block output. In an index block 1748, a pseudo rule index value is calculated by multiplying the partition number 0 times the partition size 4 and then adding the output of FFS block 1728, yielding a value of 1. Similarly, in an index block 1750, a pseudo rule index value is calculated by multiplying the partition number 0 times the partition size 4 and then adding the output of FFS block 1746, yielding a value of 8.

Once the pseudo rule index values are obtained, their corresponding rules are identified by indexing the rule-map and then compared by a comparator 1740. The true rule with the highest priority is selected by the comparator, and this rule is used for forwarding the packet. In the example illustrated in FIG. 17b, the true rules are Rule 8 (from partition 0) and Rule 3 (from partition 2). Since 3<8, the rule with the highest priority is Rule 3.

FIG. 18 depicts the result of another example using ACL 1300, rule map 1400, and the partitions of FIGS. 16a-e. In this example, a received packet has the following header values:

| Src IP Addr. | Dest. IP Addr. | Src. Port | Dest. Port | Protocol |
|---|---|---|---|---|
| 80.2.24.100 | 100.2.2.20 | 20 | 4 | TCP |

The resulting partitioned bit vectors 1750 are shown in FIG. 18. These are logically ANDed, resulting in a bit vector ‘10100000.’ This indicates only the only portions of the rule bit vectors 1752 that need to be ANDed are the portion corresponding to partition 1 and partition 3. The result of ANDing the partition 1 portion is ‘0000’, indicating no rules in partition 1 are applicable. Meanwhile, the result of ANDing the partition 3 portion is ‘0101.’ Thus, the applicable true rule is located by identifying the second rule in partition 3. Using a rule map 1400 of FIG. 14, the result is pseudo rule 10, which maps to true rule 11. As a check, it is verified that rule 11 is applicable to for the packet, as shown below:

| | Src IP | Dest. | | | |
|---|---|---|---|---|---|
| | Addr./Pre | IP Addr./Pre | Src. Port | Dest. Port | Protocol |
| Header | 80.2.24.100 | 100.2.2.20 | 20 | 4 | TCP |
| Rule 11 | 80.2./16 | * | * | * | TCP |

Prefix Pair Bit Vector (PPBV)

The Prefix Pair Bit Vector (PPBV) algorithm employs a two-stage process to identify a highest-priority matching rule. During the first stage, all prefix pairs that match a packet are found, and corresponding prefix pair bit vector are retrieved. Then, during the second stage, a linear search of the other fields (e.g., ports, protocol, flags) of each applicable prefix pair (as identified by the PPBVs) is performed to get highest-priority matching rule.

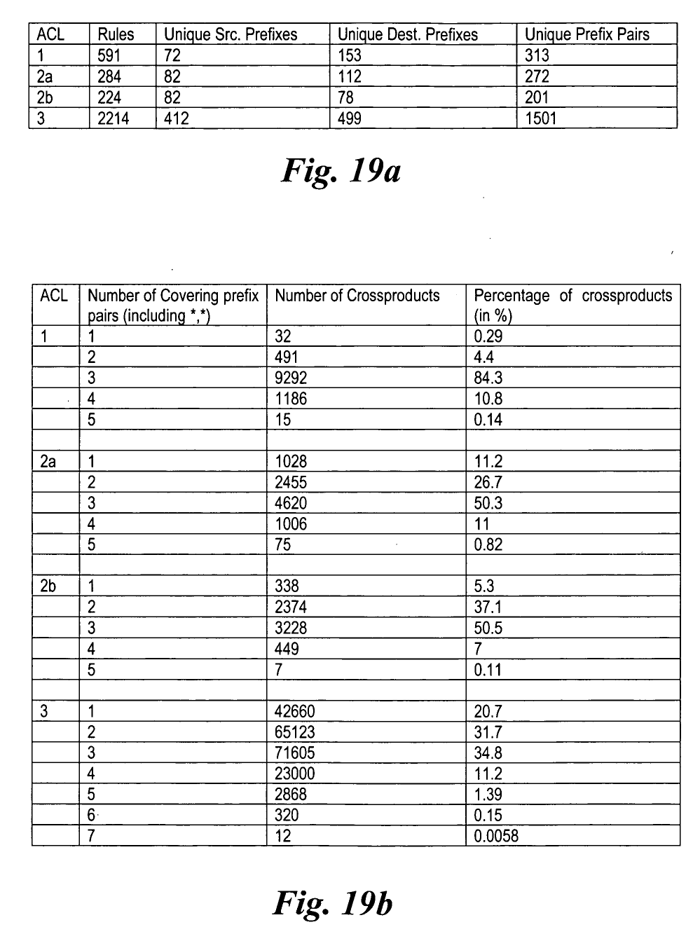

The motivation for the algorithm is based on the observation that a given packet matches few prefix pairs. The results from modeling some exemplary ACLS indicates that no prefix pair is covered by more than 4 others (including *,*). All unique source and destination prefixes were also cross-producted. The number of prefix pairs covering the cross-products for exemplary ACLs 1, 2a, 2b and 3 is shown in FIGS. 19a and 19b

We can continue to expect a given IP address pair matching few prefix pairs. This is because 90% of the prefixes in the core routing table do not have more than one covering prefix, as identified by Harsha Narayan, Ramesh Govindan and George Varghese, The Impact of Address Allocation and Routing on the Structure and Implementation of Routing Tables, ACM SIGCOMM 2003). This is based on common routing and address allocation practices.

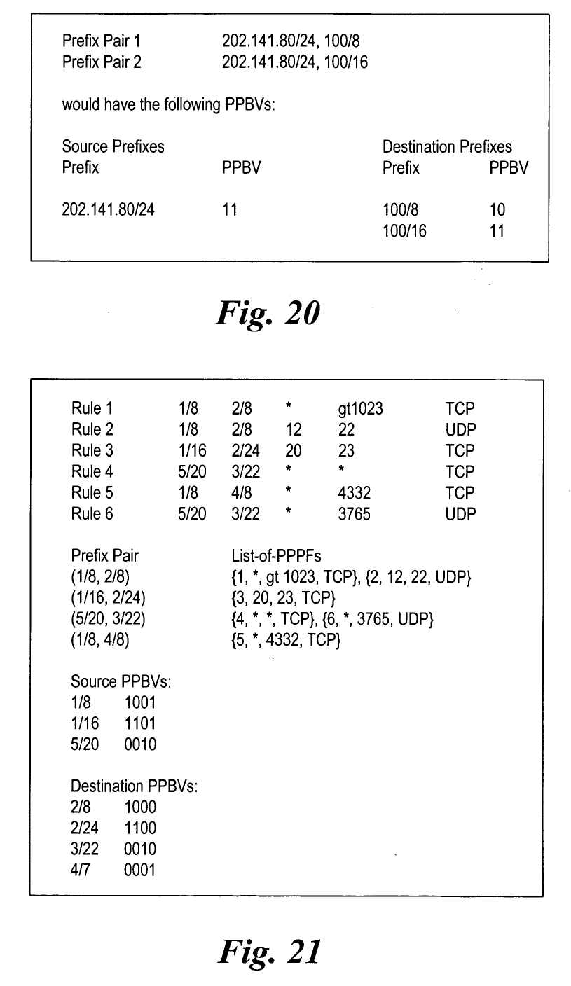

PPBV derives its name from using bit vectors that employ bits corresponding to respective prefix pairs of the ACL used for a PPBV implementation. An example of is shown in FIG. 20.

Stage 1: Finding the Prefix Pairs.

PPVB employs the use of a source prefix trie and a source destination trie to find the prefix pairs. A bit vector is then be built, wherein each bit corresponds to a respective prefix pair. In some embodiments, the PPVB bit vector algorithm may implement a partitioned bit vector algorithm or a pure aggregated bit vector algorithm, both as described above.

The length of the bit vector is equal to the number of unique prefix pairs in the ACL. These bit vectors are referred to as prefix pair bit vectors (PPBVs). For example, ACL3 has 1500 unique prefix pairs among 2200 rules. Accordingly, the PPBV for ACL# is 1500 bits long. Each unique source and destination prefix is associated with a prefix pair bit vector.

We begin with two tries, for the unique source and destination prefixes respectively. Each prefix p has a PPBV associated with it. The PPBV has a bit set for every prefix pair that matches p in p's dimension. For example, if p is a source prefix, p's PPBV would have bits set for all prefix pairs whose source prefix matches p.

A PPPF is an instance of {Priority, Port ranges, Protocol, Flags}. Each prefix pair is associated with one or more such PPPFs. The list of PPPFs that each prefix pair is associated with is called a “List-of-PPPF.”

Stage 1 Lookup Process

The lookup process for finding the matching prefix pairs, given an input packet header, is similar to the lookup process employed by the bit vector algorithm. First, a longest matching prefix lookup is performed on the source and destination tries. This yields two PPBVs—one for the source and one for the destination. The source PPBV contains set bits for those prefix pairs with a source prefix that can match the given source address of the packet. Similarly, the destination PPBV contains set bits for those prefix pairs with a destination prefix that can match the given destination address of the packet. Next, the source and destination PPBV are ANDed together. This produces a final PPBV that contains set bits for prefix pairs that match both the source and destination address of the packet. The set bits in this final PPBV are used to fetch pointers to the respective List-of-PPPF. The final PPBV is handed off to Stage 2. A linear search of the List-of-PPPF using hardware is then performed, returning the highest priority matching entry in the List-of-PPPF.

The reason the above lookup process is enough to identify all matching prefix pairs is the same as the justification for the cross-producting algorithm: A matching prefix pair will have to cover the pair=(longest source prefix match of packet, longest destination prefix match of packet).

In general, principles of the partitioned bit vector algorithm and aggregated bit vector algorithm may be applied to a PPBV implementation. For example, the PPBV could be partitioned using the partitioning algorithm explained above. This would give the benefits of a partitioned bit vector algorithm to PPBV (e.g., lowers bandwidth, memory accesses, storage). Similarly, an aggregated bit vector implementation may be employed.

FIG. 21 shows an exemplary rule set and the source and destination PPBVs and List-of-PPPFs generated therefrom. For the purposes of the examples illustrated and described herein, the PPBVs are not partitioned or aggregated. However, in an actual implementation involving 100's or 1000's of rules, it is recommended that a partitioned bit vector or aggregated bit vector approach be used.

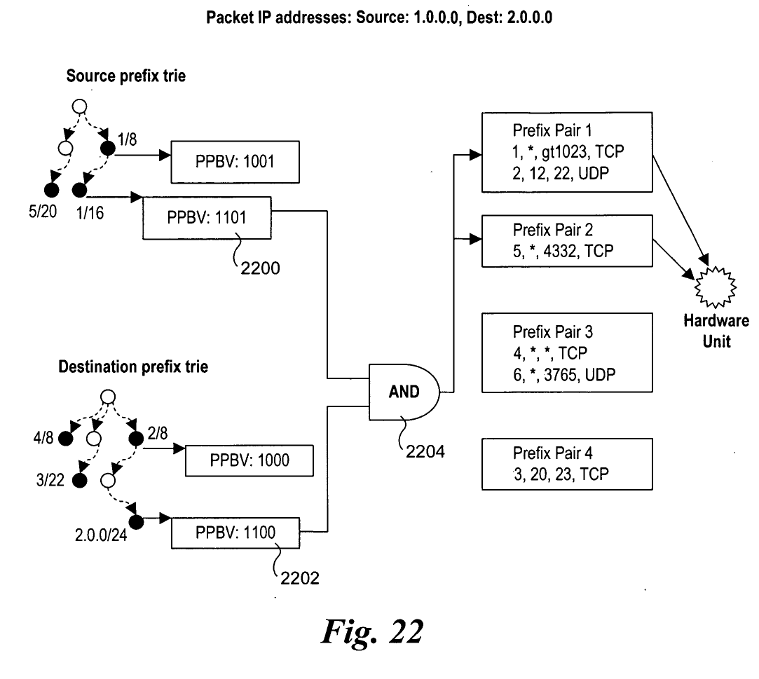

Suppose a packet is received with the address pair (1.0.0.0, 2.0.0.0). The longest matching prefix lookup in the source trie gives 1/16 as the longest match, returning a PPBV 2200 of 1101, as shown in FIG. 22. Similarly, the longest matching prefix lookup in the destination trie gives 2/24 as the longest match, returning a PPBV 2202 of 1100. Next, PPBVs 2100 and 2102 are ANDed (as depicted by an AND gate 2204, yielding 1100. This means that the packet matches the first and second prefix pairs. The transport level fields of these prefix pairs are now searched linearly using hardware.

For example, if the packet's source port=12, destination port=22 and protocol=UDP, the packet would match rule 2. Rule 2's transport level fields are present in the List-of-PPPF of prefix pair 1 (FIG. 21).

The table shown in FIG. 19a shows the number of prefix pairs matching all cross-products. For all the ACLs we have (ACLs 1, 2a, 2b and 3), we would need to examine 4 prefix pairs (including (*,*)) most of the time. Rarely would more than 4 need to be considered. If we assume that we keep the transport level fields for (*,*) in local memory, this is effectively reduced to 3 prefix pairs.

Stage 2: Searching the List-of-PPPF

Stage 1 identified a prefix pair bit vector that contains set bits for the prefix pairs that match the given packet. We now have to search the List-of-PPPF for each matching prefix pair. Recall that the List-of-PPPF is port ranges, protocol, flags, and the priority/action of rules associated with each prefix pair. We can fetch the PPPF in two ways (discussed below). In one embodiment, all the PPPFs are to be stored off-chip (to support the virtual router application, the hardware unit is interfaced to off-chip memory with this embodiment).

The format of one embodiment of the hardware unit that is required to search the PPPFs is shown in Table 13 below (the filled in values are merely exemplary). The hardware unit returns the highest priority matching rule. Each row is for a PPPF.

TABLE 13

| | Source port | Dest. Port | | |
|---|---|---|---|---|
| Priority | Range | Range | Protocol | Valid bits |
| (16 b) | (16 b—16 b) | (16 b—16 b) | (8 b) | (2 b) |
| 2 | 0-65535 | 1024-2048 | 4 | 01 |
| 4 | 0-65535 | 23-23 | 6 | 11 |
| 7 | 0-65535 | 61000-61010 | 17 | 11 |

Note that there are 2 valid bits. One is for the protocol (to handle “don't care”). The other valid bit is for the entire PPPF. In one embodiment, the PPPFs are stored as a list, with each PPPF being separated by a NULL. Thus, the valid bit indicates whether an entry is a NULL or not.

Fetching the PPPFs

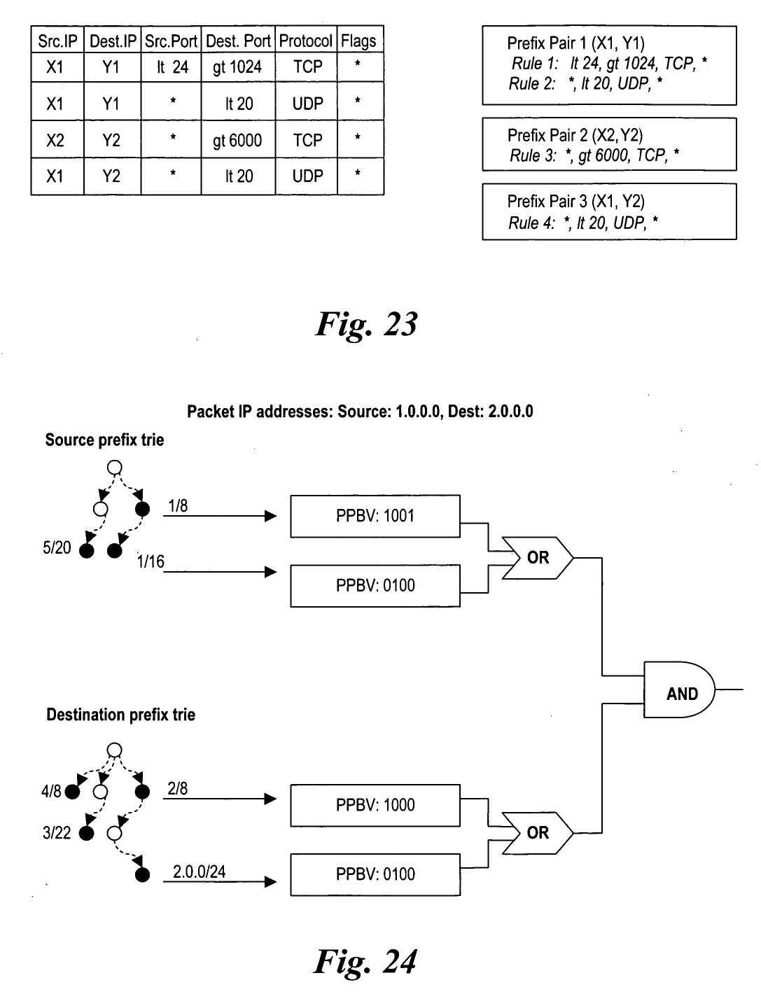

There are two ways of fetching the PPPFs, including the Option_Fast_Update and the Option_TLS. Under the Option_Fast_Update, the PPPFs are stores as they are. This requires 3 Long Words (LW) per rule. For ACL3, this requires 27 KB of storage. An example of this storage scheme is shown in FIG. 23. The List-of_PPPF for each prefix pair is shown in italics in the boxes at the right hand of the diagram.

The Option_TLS scheme is useful for memory reduction, wherein “TLS” refers to transport level sharing. Rather than storing PPPF as they are, we remove repetitions of PPPF and store pointers to unique instances. Rather than storing one pointer per PPPF, a pointer per set of PPPFs is stored. Such unique instances are called “type-3 sets”.

The criteria for forming sets of PPPFs are:
1. All PPPFs in a set have to belong to the same prefix pair; and
2. Since we need to maintain priorities among the values within each set, the values within each set have to be from rules with contiguous priorities.

For example, the set {PPPF1=[Priority=10, Source Port=*, Dest. Port gt1023, Protocol=TCP, PPPF2=[Priority=11, Source Port=*, Dest. Port gt1023, Protocol=UDP]} is valid. On the other hand, the following set {PPPF1=[Priority=10, Source Port=*, Dest. Port gt1023, Protocol=TCP, PPPF2=[Priority=12, Source Port=*, Dest. Port gt1023, Protocol=UDP]} is invalid.

A List-of-PPPF now becomes a list of pointers to such PPPF sets. Attached to each pointer is the priority of the first element of the set. This priority is used to calculate the priority of any member of the set (by an addition).

Getting Fast Updates

Fast updates with PPBV can be obtained provided: tries are used rather than RFC chunks to access the bit vectors; and the PPPFs are stored using the Option_Fast_Update storage scheme. Note that a PPBV for a prefix contains set bits for prefix pairs of all less-specific prefixes. Accordingly, a longest matching prefix lookup is sufficient to get all the matching prefix pairs.

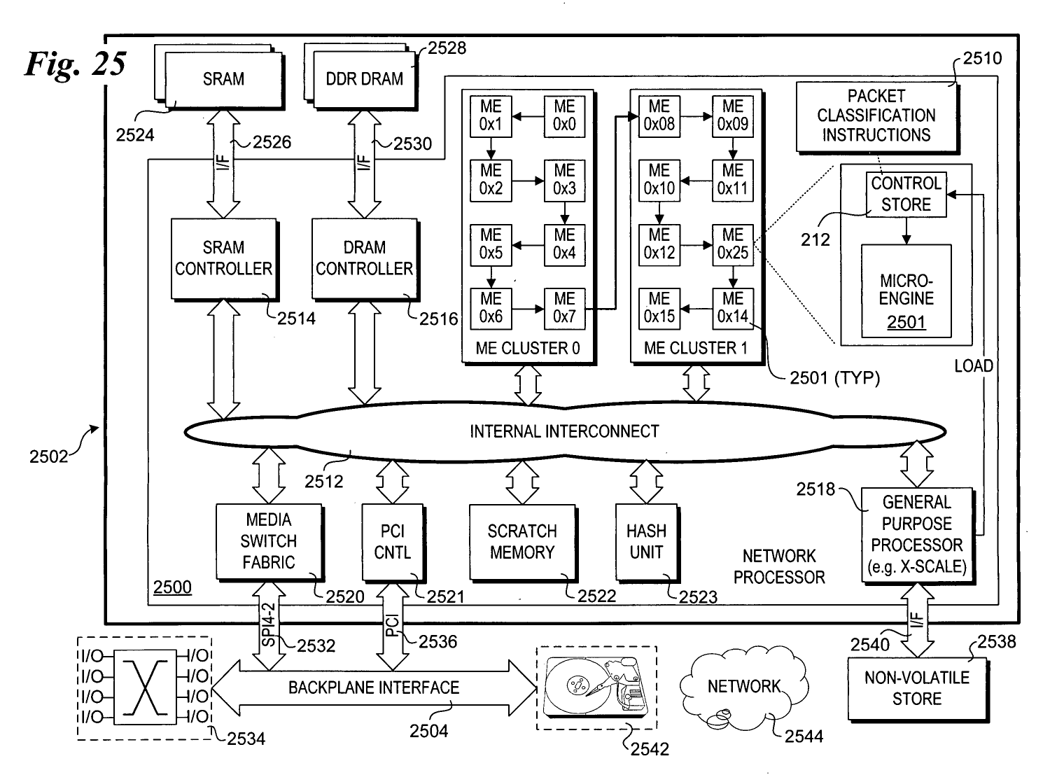

Even faster updates can be obtained if the PPBVs are logically ORed during lookup (as shown in FIG. 24) rather than during setup. Since ORing operations of this type are expensive to implement in software, it is suggested this type of implementation be performed in hardware. Under a hardware-based ORing, the update time would be the time for two longest matching prefix lookups+O(1).

Support for Run-Time Phase Operations

Software may also be executed on appropriate processing elements to perform the run-time phase operations described herein. In one embodiment, such software is implemented on a network line card implementing Intel® IPX 2xxx network processors.

For example, FIG. 25 shows an exemplary implementation of a network processor 2500 that includes one or more compute engines (e.g., microengines) that may be employed for executing software configured to perform the run-time phase operations described herein. In this implementation, network processor 2500 is employed in a line card 2502. In general, line card 2502 is illustrative of various types of network element line cards employing standardized or proprietary architectures. For example, a typical line card of this type may comprises an Advanced Telecommunications and Computer Architecture (ATCA) modular board that is coupled to a common backplane in an ATCA chassis that may further include other ATCA modular boards. Accordingly the line card includes a set of connectors to meet with mating connectors on the backplane, as illustrated by a backplane interface 2504. In general, backplane interface 2504 supports various input/output (I/O) communication channels, as well as provides power to line card 2502. For simplicity, only selected I/O interfaces are shown in FIG. 25, although it will be understood that other I/O and power input interfaces also exist.

Network processor 2500 includes n microengines 2501. In one embodiment, n=8, while in other embodiment n=16, 24, or 32. Other numbers of microengines 2501 may also be used. In the illustrated embodiment, 16 microengines 2501 are shown grouped into two clusters of 8 microengines, including an ME cluster 0 and an ME cluster 1.

In the illustrated embodiment, each microengine 2501 executes instructions (microcode) that are stored in a local control store 2508. Included among the instructions for one or more microengines are packet classification run-time phase instructions 2510 that are employed to facilitate the packet classification operations described herein.

Each of microengines 2501 is connected to other network processor components via sets of bus and control lines referred to as the processor “chassis”. For clarity, these bus sets and control lines are depicted as an internal interconnect 2512. Also connected to the internal interconnect are an SRAM controller 2514, a DRAM controller 2516, a general purpose processor 2518, a media switch fabric interface 2520, a PCI (peripheral component interconnect) controller 2521, scratch memory 2522, and a hash unit 2523. Other components not shown that may be provided by network processor 2500 include, but are not limited to, encryption units, a CAP (Control Status Register Access Proxy) unit, and a performance monitor.

The SRAM controller 2514 is used to access an external SRAM store 2524 via an SRAM interface 2526. Similarly, DRAM controller 2516 is used to access an external DRAM store 2528 via a DRAM interface 2530. In one embodiment, DRAM store 2528 employs DDR (double data rate) DRAM. In other embodiment DRAM store may employ Rambus DRAM (RDRAM) or reduced-latency DRAM (RLDRAM).

General-purpose processor 2518 may be employed for various network processor operations. In one embodiment, control plane operations are facilitated by software executing on general-purpose processor 2518, while data plane operations are primarily facilitated by instruction threads executing on microengines 2501.

Media switch fabric interface 2520 is used to interface with the media switch fabric for the network element in which the line card is installed. In one embodiment, media switch fabric interface 2520 employs a System Packet Level Interface 4 Phase 2 (SPI4-2) interface 2532. In general, the actual switch fabric may be hosted by one or more separate line cards, or may be built into the chassis backplane. Both of these configurations are illustrated by switch fabric 2534.

PCI controller 2522 enables the network processor to interface with one or more PCI devices that are coupled to backplane interface 2504 via a PCI interface 2536. In one embodiment, PCI interface 2536 comprises a PCI Express interface.

During initialization, coded instructions (e.g., microcode) to facilitate various packet-processing functions and operations are loaded into control stores 2508, including packet classification instructions 2510. In one embodiment, the instructions are loaded from a non-volatile store 2538 hosted by line card 2502, such as a flash memory device. Other examples of non-volatile stores include read-only memories (ROMs), programmable ROMs (PROMs), and electronically erasable PROMs (EEPROMs). In one embodiment, non-volatile store 2538 is accessed by general-purpose processor 2518 via an interface 2540. In another embodiment, non-volatile store 2538 may be accessed via an interface (not shown) coupled to internal interconnect 2512.

In addition to loading the instructions from a local (to line card 2502) store, instructions may be loaded from an external source. For example, in one embodiment, the instructions are stored on a disk drive 2542 hosted by another line card (not shown) or otherwise provided by the network element in which line card 2502 is installed. In yet another embodiment, the instructions are downloaded from a remote server or the like via a network 2544 as a carrier wave.

Thus, embodiments of this invention may be used as or to support a software program executed upon some form of processing core or otherwise implemented or realized upon or within a machine-readable medium. A machine-readable medium includes any mechanism for storing or transmitting information in a form readable by a machine (e.g., a computer). For example, a machine-readable medium can include such as a read only memory (ROM); a random access memory (RAM); a magnetic disk storage media; an optical storage media; and a flash memory device, etc. In addition, a machine-readable medium can include propagated signals such as electrical, optical, acoustical or other form of propagated signals (e.g., carrier waves, infrared signals, digital signals, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. A method, comprising:
partitioning rules in an access control list (ACL) into a plurality of partitions, each partition defined by a meta-rule comprising a set of filter dimension ranges and/or values covering the rules in that partition;
building a plurality of filter data structures, each including a plurality of filter entries defining packet header filter criteria corresponding to one or more filter dimensions; and
storing partition data identifying, for each filter entry, any partition having a meta-rule defining a filter dimension range or value that covers that entry's packet header filter criteria.

2. The method of claim 1, wherein the plurality of filter data structures comprise recursive flow classification (RFC) chunks.

3. The method of claim 1, wherein the plurality of filter data structures comprise trie data structures.

4. The method of claim 1, wherein a first portion of the plurality of filter data structures comprise recursive flow classification (RFC) chunks, and a second portion of the plurality of filter data structure comprise trie data structures.

5. The method of claim 1, further comprising:
defining a plurality of partition bit vectors, each partition bit vector including a string of bits, each bit position in the string associated with a corresponding partition; and
storing the partition bit vectors in a manner that links each filter entry to a corresponding partition bit vector.

6. The method of claim 5, further comprising:
defining a rule map containing a plurality of entries, each entry mapping a pseudo rule index to a corresponding rule in the ACL; and
storing the rule map in a data structure.

7. The method of claim 1, further comprising:
identifying a potential partitioning that may be implemented by partitioning along a dimension range at a depth below a covering range comprising one of a source prefix range or destination prefix range;
removing the covering range; and
employing the dimension range to partition along to form a plurality of partitions.

8. The method of claim 7, further comprising:
replicating rules across at least one partition boundary used to form the plurality of partitions.

9. The method of claim 1, wherein at least one partition is defined by a prefix pair comprising a source prefix range or value and a destination prefix range or value.

10. The method of claim 1, further comprising:
storing the filter data structures and the partition data in at least one file.

11. The method of claim 1, further comprising:
defining a plurality of rule bit vectors, each rule bit vector including a string of bits, each bit position in the string associated with a corresponding rule; and
storing the rule bit vectors in a manner that links each filter entry to a corresponding rule bit vector.

12. A method comprising:
extracting header data from a packet based on filter dimension criteria defined by an access control list (ACL) employed for packet classification;
for each filter dimension in the filter dimension criteria,
employing header data that is extracted corresponding to that filter dimension to identify an applicable entry in a corresponding filter data structure including a set of ranges and/or values corresponding to the filter dimension; and
retrieving a partition bit vector corresponding to the entry, the partition bit vector including a string of bits, each bit position in the string associated with a corresponding partition for the ACL;
logically ANDing the partition bit vectors together to identify one or more partitions to be searched;
for each entry that is identified,
retrieving portions of a rule bit vector associated with that entry, the portions corresponding to the one or more partitions to be searched;
for each of the one or more partitions,
logically ANDing the bit vector portions corresponding to that partition to identify a highest-priority rule for that partition; and
comparing the highest-priority rules to identify a rule with the highest priority.

13. The method of claim 12, wherein the filter data structures comprise reverse flow classification (RFC) chunks, and the header data corresponding to a given filter dimension is employed as an index into a corresponding RFC chunk that locates the applicable entry.

14. The method of claim 12, wherein the filter data structures comprise trie data structures, and the header data corresponding to a given filter dimension is used to perform a longest match lookup into a corresponding trie data structure that locates the applicable entry.

15. The method of claim 12, further comprising:
for each partition included in the one or more partitions to be searched,
determining a bit position of the highest priority rule identified for the partition;
determining a pseudo rule index based on the bit position and the partition;
indexing into a rule map using the pseudo rule index, the rule map mapping pseudo rule indexes to corresponding rules; and
employing the rule corresponding to the pseudo rule index has the highest priority rule for the partition.

16. The method of claim 12, wherein the filter dimensions comprise:
the first 16 bits of a source address;
the second 16 bits of the source address;
the first 16 bits of a destination address;
the second 16 bits of the destination address;
a source port value:
a destination port value; and
a protocol value.

17. A machine-readable medium, to store instructions that if executed perform operations comprising:
extracting header data including a source address, a destination address, a source port, and destination port, and a protocol field value from a packet;
for each dimension defined for a packet classification scheme employing a partitioned access control list (ACL) including a plurality of partitions, each partition including a corresponding set of rules for forwarding packets;
employing header data corresponding to the dimension as an input to a lookup process that locates a matching entry in a filter data structure corresponding to the dimension; and
retrieving a partition bit vector corresponding to the entry from memory, the partition bit vector including a string of bits, each bit position in the string associated with a corresponding partition for the ACL;
logically ANDing the partition bit vectors together to identify one or more partitions to be searched;
for each entry that is identified,
retrieving portions of a rule bit vector associated with that entry from memory, the portions corresponding to the one or more partitions to be searched;
for each of the one or more partitions,
logically ANDing the bit vector portions corresponding to that partition to identify a highest-priority rule for that partition; and
comparing the highest-priority rules to identify a rule with the highest priority.

18. The machine-readable medium of claim 17, wherein the filter data structures comprise recursive flow classification (RFC) chunks, and execution of the instructions performs further operations comprising:
calculating an index value based on the header data corresponding to a given filter dimension; and
employing the index value to locate the applicable entry corresponding to the header data in the RFC chunk.

19. The machine-readable medium of claim 17, wherein the filter data structures comprise trie data structures, and execution of the instructions performs further operations comprising:
identifying an applicable entry in a trie data structure corresponding to a given dimension by performing a longest match between the header data corresponding to that dimension and an entry in a corresponding trie data structure.

20. The machine-readable medium of claim 17, wherein execution of the instructions performs further operations comprising:
for each partition included in the one or more partitions to be searched,
determining a bit position of the highest priority rule identified for the partition;
determining a pseudo rule index based on the bit position and the partition;
indexing into a rule map using the pseudo rule index, the rule map mapping pseudo rule indexes to corresponding rules; and
employing the rule corresponding to the pseudo rule index as the highest priority rule for the partition.

21. A network line card, comprising:
a network processor,
a plurality of input/output (I/O) ports, communicatively-coupled to the network processor;
memory, communicatively-coupled to the network processor; and
a storage device, communicatively-coupled to the network processor, having instructions stored therein that if executed perform operations comprising:
extracting header data including a source address, a destination address, a source port, and destination port, and a protocol field value from a packet;
for each dimension defined for a packet classification scheme employing a partitioned access control list (ACL) including a plurality of partitions, each partition including a corresponding set of rules for forwarding packets;
employing header data corresponding to the dimension as an input to a lookup process that locates a matching entry in a filter data structure corresponding to the dimension; and
retrieving a partition bit vector corresponding to the entry from memory, the partition bit vector including a string of bits, each bit position in the string associated with a corresponding partition for the ACL;
logically ANDing the partition bit vectors together to identify one or more partitions to be searched;
for each entry that is identified,
retrieving portions of a rule bit vector associated with that entry from memory, the portions corresponding to the one or more partitions to be searched;
for each of the one or more partitions,
logically ANDing the bit vector portions corresponding to that partition to identify a highest-priority rule for that partition; and
comparing the highest-priority rules to identify a rule with the highest priority.

22. The network line card of claim 21, wherein the filter data structures comprise trie data structures, and execution of the instructions performs further operations comprising:
identifying an applicable entry in a trie data structure corresponding to a given dimension by performing a longest match between the header data corresponding to that dimension and an entry in a corresponding trie data structure.

23. The network line card of claim 21, wherein execution of the instructions performs further operations comprising:
for each partition included in the one or more partitions to be searched,
determining a bit position of the highest priority rule identified for the partition;
determining a pseudo rule index based on the bit position and the partition;
indexing into a rule map using the pseudo rule index, the rule map mapping pseudo rule indexes to corresponding rules; and
employing the rule corresponding to the pseudo rule index as the highest priority rule for the partition.
